(19) United States
(12) Patent Application Publication
(10) Pub. No.: US 2024/0391775 A1
(43) Pub. Date: Nov. 28, 2024

(54) POLYPHOSPHATE MATERIALS

(71) Applicants: JUNJI SAKAMOTO, Cambridge, MA (US); Alexei TEN, Cambridge, MA (US); Mohamad KODAIMATI, Cambridge, MA (US); Haihui Joy JIANG, Cambridge, MA (US); Amit Arun NAGARKAR, Boston, MA (US); Samuel E. ROOT, Cambridge, MA (US); George M. WHITESIDES, Cambridge, MA (US)

(72) Inventors: JUNJI SAKAMOTO, Cambridge, MA (US); Alexei TEN, Cambridge, MA (US); Mohamad KODAIMATI, Cambridge, MA (US); Haihui Joy JIANG, Cambridge, MA (US); Amit Arun NAGARKAR, Boston, MA (US); Samuel E. ROOT, Cambridge, MA (US); George M. WHITESIDES, Cambridge, MA (US)

(21) Appl. No.: 18/694,064

(22) PCT Filed: Sep. 23, 2022
(86) PCT No.: PCT/US2022/076956

§ 371 Date: Mar. 21, 2024

Related U.S. Application Data
(60) Provisional application No. 63/398,036, filed on Aug. 15, 2022.
(60) Provisional application No. 63/248,691, filed on Sep. 27, 2021.

(51) Int. Cl. C01B 25/41

(52) U.S. Cl. CPC C01B 25/41; C01P 2006/10; C01P 2006/12; C01P 2006/34

(57) ABSTRACT

A polyphosphate material is disclosed. The polyphosphate material can include a plurality of polyphosphate chains. The polyphosphate chains can have a backbone that include oxygen-phosphate bonds. Two or more cations can be included. Further, the polyphosphate material can be amorphous. The two or more cations can be monovalent cations, divalent cations, trivalent cations, tetravalent cations, and combinations thereof. The two or more cations can be lithium, sodium, potassium, rubidium, cesium, francium, ammonium, beryllium, magnesium, calcium, strontium, barium, radium, zinc, titanium, iron (Fe²⁺), chromium (Cr²⁺), manganese (Mn²⁺), cobalt (Co²⁺), nickel (Ni²⁺), copper (Cu²⁺), cadmium, tin (Sn²⁺), mercury (Hg²⁺), lead (Pb²⁺), aluminum, boron, gallium, iron (Fe⁺³), chromium (Cr⁺³), cobalt (Co⁺³), gold (Au⁺³), antimony (Sb⁺³), nickel (Ni⁺³), bismuth (Bi⁺³), manganese (Mn⁺³) zirconium, silicon, and combinations of thereof. The two or more cations can be monovalent cations. The two or more cations can be sodium and potassium or potassium and lithium.

### RELATED APPLICATION

This application claims priority to U.S. Provisional Application Ser. No. 63/398,036, entitled “POLYPHOSPHATE MATERIALS”, filed Aug. 15, 2022, and U.S. Provisional Application Ser. No. 63/248,691, entitled “POLYPHOSPHATE FOAMS”, filed Sep. 27, 2021, the contents of both of which are hereby incorporated by reference in their entireties.

### COPYRIGHT NOTICE

This patent disclosure may contain material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### FIELD OF THE INVENTION

The instant application relates to polyphosphate materials. In particular, the instant application relates to plasticized polyphosphate materials and polyphosphate foams.

### BACKGROUND

Many polymers, either natural or synthetic, are carbon-based materials. Combustion of organic polymers emits CO₂ into the atmosphere, which contributes to global warming. In addition, petroleum-derived commodity polymers are chemically stable and accumulate in the environment after use, causing serious marine pollution disturbing the ecosystem. There is a growing demand to replace synthetic polymers with sustainable materials that can be recycled and have minimum CO₂ emissions during their production and recycling processes. Polyphosphate materials can meet such a demand. Polyphosphate materials can be thermally stable once formed. However, polyphosphate typically forms semi-crystalline solids. Polyphosphate can be hydrolytic and hard to process, limiting the scope of its material-related applications. The processing of such crystalline polyphosphate into materials of various shapes and morphologies is a challenge due to their high melting temperatures and insolubility in organic solvents

### SUMMARY

In some embodiments, a polyphosphate material comprises a plurality of polyphosphate chains having a backbone comprising oxygen-phosphate bonds. The polyphosphate material further comprises two or more cations. The polyphosphate material is amorphous.

In some embodiments, the two or more cations are selected from a group consisting of monovalent cations, divalent cations, trivalent cations, tetravalent cations, and combinations thereof. In some embodiments, the two or more cations are selected from the group consisting of lithium, sodium, potassium, rubidium, cesium, francium, ammonium, beryllium, magnesium, calcium, strontium, barium, radium, zinc, titanium, iron (Fe²), chromium (Cr²⁺), manganese (Mn²⁺), cobalt (Co²⁺), nickel (Ni²⁺), copper (Cu²⁺), cadmium, tin (Sn²⁺), mercury (Hg²⁺), lead (Pb²⁺), aluminum, boron, gallium, iron (Fe³⁺), chromium (Cr³⁺), cobalt (Co³⁺), gold (Au³⁺), antimony (Sb³⁺), nickel (Ni³⁺), bismuth (Bi³⁺), manganese (Mn³⁺), zirconium, silicon, manganese (Mn⁴⁺), titanium (Ti⁴⁺), and combinations of thereof. In some embodiments, the two or more cations comprise monovalent cations. In some embodiments, the two or more cations comprise sodium and potassium. In some embodiments, the two or more cations comprise potassium and lithium. In some embodiments, the polyphosphate material has a glass transition temperature of less than 250° C. In some embodiments, the polyphosphate material has a melting temperature less than 500° C. In some embodiments, the polyphosphate material is transparent. In some embodiments, the polyphosphate material is a gel. In some embodiments, the gel comprises charged particles. In some embodiments, the polyphosphate material is a thermoplastic material. In some embodiments, the polyphosphate material is an adhesive. In some embodiments, the polyphosphate material is a film. In some embodiments, the polyphosphate material is hydrophobic. In some embodiments, hydrophobic cations are included. In some embodiments, a dissolved metal salt is included. In some embodiments, the dissolved metal salt is selected from the group selected from copper salts, magnesium salts, chromium slats, europium salts, iron salts, titanium salts, chromium salts, manganese salts, cobalt salts, nickel salts, tin salts, mercury salts, lead salts, chromium salts, cobalt salts, gold salts, antimony salts, bismuth salts, and combinations thereof.

In some embodiments, a method of forming a polyphosphate material comprises adding a polyphosphate powder comprising a first cation to a solution of a salt of a second cation. The method also comprises heating the solution to dissolve the polyphosphate powder. Further, the method comprises cooling the solution to cause phase separation into an upper liquid layer and a lower liquid layer, wherein the lower liquid layer comprises a coacervate of polyphosphate. Moreover, the method includes collecting the coacervate.

In some embodiments, heating the solution comprises heating the solution to a temperature of at 80° C. In some embodiments, cooling the solution comprises cooling the solution to a temperature of less than 4° C. In some embodiments, the first cation and the second cation are selected from a group consisting of monovalent cations, divalent cations, trivalent cations, tetravalent cations, and combinations thereof. In some embodiments, the first cation and second cation are selected from the group consisting of lithium, sodium, potassium, rubidium, cesium, francium, ammonium, beryllium, magnesium, calcium, strontium, barium, radium, zinc, titanium, iron (Fe²⁺), chromium (Cr²), manganese (Mn²⁺), cobalt (Co²⁺), nickel (Ni²⁺), copper (Cu²⁺), cadmium, tin (Sn²⁺), mercury (Hg²⁺), lead (Pb²⁺), aluminum, boron, gallium, iron (Fe⁺³), chromium (Cr⁺³), cobalt (Co⁺³), gold (Au⁺³), antimony (Sb⁺³), nickel (Ni⁺³), bismuth (Bi⁺³), manganese (Mn⁺³), zirconium, silicon, manganese (Mn⁴⁺), titanium (Ti⁴⁺), and combinations of thereof. In some embodiments, the first cation is potassium, and the second cation is sodium or lithium. In some embodiments, the coacervate is swelled with a solution of a salt of the second cation. In some embodiments, the coacervate is mixed with charged particles to form crosslinks. In some embodiments, a substrate can be coated with the coacervate. In some embodiments, one of the first cation or the second cation is replaced with a hydrophobic cation.

In some embodiments, a method of forming a polyphosphate material comprises providing a first phosphate monomer comprising a first cation. The method further comprises providing a second phosphate monomer comprising a second cation. Moreover, the method comprises heating the first phosphate monomer and second phosphate monomer to form a liquid. The method also comprises cooling the liquid to form an amorphous polyphosphate material.

In some embodiments, the amorphous polyphosphate is dissolved in water mixing with charged particles to form crosslinks. In some embodiments, the solution is heated to a temperature of at least 350° C. In some embodiments, the first cation and the second cation are selected from a group consisting of monovalent cations, divalent cations, trivalent cations, tetravalent cations, and combinations thereof. In some embodiments, the first cation and second cation are selected from the group consisting of lithium, sodium, potassium, rubidium, cesium, francium, ammonium, beryllium, magnesium, calcium, strontium, barium, radium, zinc, titanium, iron (Fe²⁺), chromium (Cr²⁺), manganese (Mn²⁺), cobalt (Co²⁺), nickel (Ni²⁺), copper (Cu²⁺), cadmium, tin (Sn²⁺), mercury (Hg²⁺), lead (Pb²⁺), aluminum, boron, gallium, iron (Fe⁺³), chromium (Cr⁺³), cobalt (Co⁺³), gold (Au⁺³), antimony (Sb⁺³), nickel (Ni⁺³), bismuth (Bi⁺³), manganese (Mn⁺³), zirconium, silicon, manganese (Mn⁴⁺), titanium (Ti⁴⁺), and combinations of thereof. In some embodiments, in the first cation is potassium, and the second cation is sodium. In some embodiments the first cation and the second cation are both Group I cations. In some embodiments, the first cation is potassium, and the second cation is lithium. In some embodiments, the first cation and the second cation are both Group I cations. In some embodiments, the amorphous polyphosphate material is grinded to form a powder. In some embodiments, a metal salt is melted in the liquid. In some embodiments, the metal salt is selected from the group selected from copper salts, magnesium salts, chromium slats, europium salts, iron salts, titanium salts, chromium salts, manganese salts, cobalt salts, nickel salts, tin salts, mercury salts, lead salts, chromium salts, cobalt salts, gold salts, antimony salts, bismuth salts, and combinations thereof. In some embodiments, the liquid is used to adhere a first substrate to a second substrate. In some embodiments, one of the first cation or the second cation is replaced with a hydrophobic cation. In some embodiments, the amorphous polyphosphate material is heat pressed to form a film.

In some embodiments, a polyphosphate material comprises a plurality of polyphosphate chains having a backbone comprising oxygen-phosphate bonds. The polyphosphate materials also comprised one or more multivalent cations forming crosslinks between the polyphosphate chains. The polyphosphate material is porous.

In some embodiments, the polyphosphate material has a density of less than 0.15 g/cm². In some embodiments, the one or more multivalent cations comprise two or more different multivalent cations. In some embodiments, the one or more multivalent cations are selected from a group consisting of trivalent cations, tetravalent cations, and combinations thereof. In some embodiments, the one or more multivalent cations are selected from a group consisting of aluminum, boron, gallium, iron (Fe⁺³), chromium (Cr⁺³), cobalt (Co⁺³), gold (Au⁺³), antimony (Sb⁺³), nickel (Ni⁺³), bismuth (Bi⁺³), manganese (Mn⁺³), zirconium, silicon, manganese (Mn⁴⁺), titanium (Ti⁴⁺), and combinations of thereof. In some embodiments, the one or more cations comprise a trivalent cation. In some embodiments, the one or more cations comprise aluminum. In some embodiments, one or more of iron (Fe²⁺ or Fe³⁺) and tin (Sn²⁺ or Sn⁴⁺) are included. In some embodiments, a nanomaterial is included. In some embodiments, the nanomaterial is selected from a group consisting of metal oxide nanoparticles, metal nanoparticles, metal nanorods, carbon fibers, clays, organic hybrids, silica, borosilicate, borate containing materials, and combinations thereof. In some embodiments, the metal oxide nanoparticles are selected from a group consisting of zirconia, titania, silica, alumina, zinc oxide, magnesium oxide, iron oxide, copper oxide, and combinations thereof. In some embodiments, a metal oxide is included. In some embodiments, the metal oxide is selected from a group consisting of zirconia, titania, silica, alumina, zinc oxide, magnesium oxide, iron oxide, copper oxide, and combinations thereof. In some embodiments, the polyphosphate material has a density of less than 0.05 g/cm³. In some embodiments, the polyphosphate material has a porosity of at a maximum of 70%. In some embodiments, the polyphosphate material has a surface area of at least 0.5 m²/g. In some embodiments, the polyphosphate material comprises an interconnected network of pores. In some embodiments, the polyphosphate material has a compressive strength of at least 100 kPa. In some embodiments, the polyphosphate material decomposes at a temperature of at least 800° C. In some embodiments, the polyphosphate material is biodegradable.

In some embodiments, a method of forming a polyphosphate material comprises providing a mixture of a phosphate monomer comprising a multivalent cation. The method also comprises heating the mixture to form a polyphosphate foam.

In some embodiments, the mixture is heated to a temperature of at least 500° C. In some embodiments, heating the mixture comprises rapidly heating the mixture. In some embodiments, heating the mixture forms bubbles. In some embodiments, the one or more multivalent cations comprise two or more different multivalent cations. In some embodiments, the one or more multivalent cations are selected from a group consisting of trivalent cations, tetravalent cations, and combinations thereof. In some embodiments, the one or more multivalent cations are selected from a group consisting of aluminum, boron, gallium, iron (Fe⁺³), chromium (Cr⁺³), cobalt (Co⁺³), gold (Au⁺³), antimony (Sb⁺³), nickel (Ni⁺³), bismuth (Bi⁺³), manganese (Mn⁺³), zirconium, silicon, manganese (Mn⁴⁺), titanium (Ti⁴⁺), and combinations of thereof. In some embodiments, the one or more multivalent cations comprise a trivalent cation. In some embodiments, the one or more multivalent cations comprise aluminum. In some embodiments, the polyphosphate is formed by layer-by-layer deposition. In some embodiments, a first layer of the mixture is provided. The first layer of the mixture is heated to form a polyphosphate foam. A second layer of the mixture is provided. The second layer of the mixture is heated to form a polyphosphate foam. In some embodiments, one or more of iron (Fe²⁺ or Fe³⁺) and tin (Sn²⁺ or Sn⁴⁺) is provided. In some embodiments, a nanomaterial is provided. In some embodiments, the nanomaterial is selected from a group consisting of metal oxide nanoparticles, metal nanoparticles, metal nanorods, carbon fibers, clays, organic hybrids, and combinations thereof. In some embodiments, the metal oxide nanoparticles are selected from a group consisting of zirconia, titania, silica, alumina, zinc oxide, magnesium oxide, iron oxide, copper oxide, and combinations thereof. In some embodiments, a metal oxide is provided. In some embodiments, the metal oxide is selected from a group consisting of zirconia, titania, silica, alumina, zinc oxide, magnesium oxide, iron oxide, copper oxide, and combinations thereof. In some embodiments, the polyphosphate foam has a density of less than 0.15 g/cm³. In some embodiments, the polyphosphate foam has a density of less than 0.05 g/cm³.

Any one of the embodiments disclosed herein may be properly combined with any other embodiment disclosed herein. The combination of any one of the embodiments disclosed herein with any other embodiments disclosed herein is expressly contemplated.

### BRIEF DESCRIPTION OF THE DRAWINGS

The objects and advantages will be apparent upon consideration of the following detailed description, taken in conjunction with the accompanying drawings, in which like reference characters refer to like parts throughout, and in which:

FIG. 1 shows a chemical formula of a polyphosphate, according to certain embodiments of the present disclosure.

FIG. 2A shows biological synthesis of polyphosphate, according to certain embodiments of the present disclosure.

FIG. 2B shows abiotic synthesis of polyphosphate, according to certain embodiments of the present disclosure.

FIG. 3 shows an enzymatic reaction of hydrolysis of polyphosphate using phosphatase, according to certain embodiments of the present disclosure.

FIG. 4A shows a chemical reaction of dehydration polycondensation of a dehydrogenphosphate to form a polyphosphate, according to certain embodiments of the present disclosure.

FIG. 4B shows a chemical reaction of dehydration polycondensation of potassium dihydrogenphosphate to form potassium polyphosphate with high molecular weights, according to certain embodiments of the present disclosure.

FIG. 5A shows a chemical reaction of polymerization of dihydrogenphosphates with monovalent cations to form non-crosslinked polyphosphates, according to certain embodiments of the present disclosure.

FIG. 5B shows a photograph of a polyphosphate with a monovalent cation, according to certain embodiments of the present disclosure.

FIG. 6A shows a chemical reaction of polymerization of dihydrogenphosphates with divalent cation to form crosslinked polyphosphates, according to certain embodiments of the present disclosure.

FIG. 6B shows a photograph of a polyphosphate with a divalent cation, according to certain embodiments of the present disclosure.

FIG. 7A shows a chemical reaction of polymerization of dihydrogenphosphates with trivalent metals to form highly crosslinked polyphosphates, according to certain embodiments of the present disclosure.

FIG. 7B shows a photograph of a polyphosphate with a trivalent cation, according to certain embodiments of the present disclosure.

FIG. 8A shows a chemical formula of a homo-polyphosphate, according to certain embodiments of the present disclosure.

FIG. 8B shows a photograph of a potassium phosphate, according to certain embodiments of the present disclosure.

FIG. 9A shows a chemical formula of a mixed-polyphosphate, according to certain embodiments of the present disclosure.

FIG. 9B shows a photograph of a potassium lithium phosphate, according to certain embodiments of the present disclosure.

FIG. 10 shows a schematic of a coacervate of a polyphosphate material, according to certain embodiments of the present disclosure.

FIG. 11 shows a chemical formula of an aluminum dihydrogen phosphate, according to certain embodiments of the present disclosure.

FIG. 12A shows a chemical reaction of formation of aluminum polyphosphate foam, according to certain embodiments of the present disclosure.

FIG. 12B shows aluminum polyphosphate before heating (left) and after heating (right), according to certain embodiments of the present disclosure.

FIG. 13A shows a ³¹P NMR spectrum of potassium dihydrogen phosphate (monomer) in D₂O, according to certain embodiments of the present disclosure.

FIG. 13B shows a ³¹P NMR spectrum of potassium polyphosphate (polymer) in D₂O, according to certain embodiments of the present disclosure.

FIG. 13C shows a ³¹P NMR spectrum of the polyphosphate polymer after heating at 80° C. for 24 hours in D₂O, according to certain embodiments of the present disclosure.

FIG. 14A shows a sodium polyphosphate, according to certain embodiments of the present disclosure.

FIG. 14B shows a sodium-potassium polyphosphate, according to certain embodiments of the present disclosure.

FIG. 14C shows a potassium polyphosphate, according to certain embodiments of the present disclosure.

FIG. 14D shows a lithium-potassium polyphosphate, according to certain embodiments of the present disclosure.

FIG. 14E shows a lithium polyphosphate, according to certain embodiments of the present disclosure.

FIG. 14F shows a powder X-ray diffractogram of a lithium-potassium polyphosphate according to certain embodiments of the present disclosure.

FIG. 14G shows a powder X-ray diffractogram of a potassium polyphosphate according to certain embodiments of the present disclosure.

FIG. 14H shows a powder X-ray diffractogram of a lithium polyphosphate, according to certain embodiments of the present disclosure.

FIGS. 15A-15B shows heating of a block of potassium polyphosphate, according to certain embodiments of the present disclosure.

FIGS. 15C-15D shows heating of a block of sodium-potassium polyphosphate, according to certain embodiments of the present disclosure.

FIG. 16A shows exemplary sodium-potassium polyphosphate with CuCl₂, MnSO₄, and CrCl₃ salts, according to certain embodiments of the present disclosure.

FIG. 16B shows sodium-potassium polyphosphate with EuCl₃ salts, according to certain embodiments of the present disclosure.

FIG. 16C shows sodium-potassium polyphosphate with EuCl₃ salts irradiated with 364 nm, according to certain embodiments.

FIG. 17A shows a polyphosphate coacervate, according to certain embodiments of the present disclosure.

FIG. 17B shows a polyphosphate coacervate with CuSO₄, according to certain embodiments of the present disclosure.

FIG. 17C shows a confirmation of a suspension of polyphosphate coacervate using the Tyndall effect, according to certain embodiments of the present disclosure.

FIG. 17D shows a droplet of the coacervate dispersion on a glass slide, according to certain embodiments of the present disclosure.

FIG. 18A shows a photograph of a polyphosphate gel, according to certain embodiments of the present disclosure.

FIG. 18B shows a photograph of a bent polyphosphate gel, according to certain embodiments of the present disclosure.

FIG. 18C shows a photograph of a polyphosphate gel stretched more than 20 times its original length, according to certain embodiments of the present disclosure.

FIG. 18D shows a photograph of a polyphosphate gel supporting a 350 g metal block, according to certain embodiments of the present disclosure.

FIG. 19A shows an uncoated filter paper that caught fire and burned when approaching a flame, according to certain embodiments of the present disclosure.

FIG. 19B shows a polyphosphate coated filter paper that became graphitized when approaching a flame, according to certain embodiments of the present disclosure.

FIG. 20A shows two glass vials glued together with a sodium-potassium phosphate adhesive, according to certain embodiments of the present disclosure.

FIG. 20B shows the glued vials hooked to a monkey bar at one end and a metal wrench at the other end, according to certain embodiments of the present disclosure.

FIG. 20C shows the bottom of the glued vials after a fracture, according to certain embodiments of the present disclosure.

FIG. 21A shows metal plates glued with a sodium-potassium phosphate adhesive oriented vertically, according to certain embodiments of the present disclosure.

FIG. 21B shows metal plates glued with a sodium-potassium phosphate adhesive oriented horizontally, according to certain embodiments of the present disclosure.

FIG. 21C shows a side view of metal plates glued with a sodium-potassium phosphate adhesive oriented horizontally, according to certain embodiments of the present disclosure.

FIG. 22A shows Fe₃O₄ particles glued together with a lithium-potassium polyphosphate adhesive, according to certain embodiments of the present disclosure.

FIG. 22B shows Fe₃O₄ particles glued together with a lithium-potassium polyphosphate adhesive and attracted by a magnet, according to certain embodiments of the present disclosure.

FIG. 23 shows glass glued to ceramic with a lithium-potassium polyphosphate, according to certain embodiments of the present disclosure.

FIG. 24A shows a sodium-potassium polyphosphate film formed by drying an aqueous solution of a sodium-potassium polyphosphate, according to certain embodiments of the present disclosure.

FIG. 24B shows a sodium-potassium polyphosphate film formed by flattening a polyphosphate hydrogel, according to certain embodiments of the present disclosure.

FIG. 24C shows a solid block of a transparent lithium-potassium polyphosphate, according to certain embodiments of the present disclosure.

FIG. 24D shows a transparent lithium-potassium polyphosphate with a thickness of 1 mm, according to certain embodiments of the present disclosure.

FIG. 24E shows a transparent lithium-potassium polyphosphate with a thickness of 0.5 mm, according to certain embodiments of the present disclosure.

FIG. 25A shows a ball of a hydrophobicized polyphosphate material in water in one day, according to certain embodiments of the present disclosure.

FIG. 25B shows a ball of a hydrophobicized polyphosphate material in ethanol in one day, according to certain embodiments of the present disclosure.

FIG. 25C shows a ball of a hydrophobicized polyphosphate material in pentane in one day, according to certain embodiments of the present disclosure.

FIG. 25D shows a ball of a hydrophobicized polyphosphate material in water after one week, according to certain embodiments of the present disclosure.

FIG. 25E shows a ball of a hydrophobicized polyphosphate material in ethanol after one week, according to certain embodiments of the present disclosure.

FIG. 25F shows a ball of a hydrophobicized polyphosphate material in pentane after one week, according to certain embodiments of the present disclosure.

FIG. 26A shows a photograph of an aluminum polyphosphate foam, according to certain embodiments of the present disclosure.

FIG. 26B shows an X-ray micro-CT scan of an aluminum polyphosphate foam, according to certain embodiments of the present disclosure.

FIG. 26C shows an SEM micrograph of an aluminum polyphosphate foam, according to certain embodiments of the present disclosure.

FIG. 26D shows an X-ray micro-CT scan of an aluminum polyphosphate foam, according to certain embodiments of the present disclosure.

FIG. 26E shows an X-ray micro-CT scan of an aluminum polyphosphate foam, according to certain embodiments of the present disclosure.

FIG. 26F shows an X-ray micro-CT scan of an aluminum polyphosphate foam, according to certain embodiments of the present disclosure.

FIG. 26G shows an X-ray micro-CT scan of an aluminum polyphosphate foam, according to certain embodiments of the present disclosure.

FIG. 27A shows sprinkling of powdered aluminum dihydrogen phosphate by a spray gun during layer-by-layer fabrication, according to certain embodiments of the present disclosure.

FIG. 27B shows heating of powdered aluminum dihydrogen phosphate by a gas torch during layer-by-layer fabrication, according to certain embodiments of the present disclosure.

FIGS. 27C-27E shows laser-cut aluminum polyphosphate foams formed by layer-by-layer fabrication, according to certain embodiments of the present disclosure.

FIG. 28 shows a photograph of a polyphosphate foam supporting a brick, according to certain embodiments of the present disclosure.

FIG. 29A shows a 1 mm-thick slice of aluminum polyphosphate (Al—PP) foam, according to certain embodiments of the present disclosure.

FIG. 29B shows ink dropped onto a slice of aluminum polyphosphate foam, according to certain embodiments of the present disclosure.

FIG. 29C shows ink permeating across an aluminum polyphosphate foam, according to certain embodiments of the present disclosure.

FIG. 29D shows a slice of aluminum polyphosphate foam cut across the center of an ink spot, according to certain embodiments of the present disclosure.

FIG. 29E shows a cross-section of aluminum polyphosphate foam with ink permeating the polyphosphate foam, according to certain embodiments of the present disclosure.

FIG. 30 shows a half-spherical cake made of polyphosphate material after ethanol fuel caught fire, according to certain embodiments of the present disclosure.

FIG. 31A shows a photograph of a polyphosphate foam exposed to a flame temperature of 2000° C., according to certain embodiments of the present disclosure.

FIG. 31B shows a photograph of a polyphosphate foam exposed to liquid nitrogen temperature of −196° C., according to certain embodiments of the present disclosure.

FIG. 31C shows a photograph of a steel tube partially coated with a polyphosphate foam. The coated tube is heated by a 2000° C. flame, according to certain embodiments of the present disclosure.

FIG. 31D shows an infrared image of the coated tube heated by a 2000° C. flame, according to certain embodiments of the present disclosure.

FIG. 32A shows thermogravimetric analysis (TGA) of aluminum dihydrogenphosphate, according to certain embodiments of the present disclosure.

FIG. 32B shows X-ray diffraction analysis of an aluminum polyphosphate after heating at 2000° C. for 10 minutes, according to certain embodiments of the present disclosure.

FIG. 33A shows a polyphosphate foam in vial of water, HCl aq (0.1 N), and NaOH aq (0.1 N) right after being soaked, according to certain embodiments of the present disclosure.

FIG. 33B shows a polyphosphate foam in a vial of water after 30 days, according to certain embodiments of the present disclosure.

FIG. 33C shows a polyphosphate foam in a vial of HCl aq after 30 days, according to certain embodiments of the present disclosure.

FIG. 33D shows a polyphosphate foam in a vial of NaOH aq in one day, according to certain embodiments of the present disclosure.

FIG. 34 shows a photograph of a polyphosphate foam with nano-silica that has been laser-cut, according to certain embodiments of the present disclosure.

FIG. 35A shows red kidney beans on the first day grown on watered beds of: cotton, powdered aluminum polyphosphate foam, sand mixed with 0.1 wt % powdered aluminum polyphosphate foam, sand mixed with 1 wt % powdered aluminum polyphosphate foam, sand mixed with 10 wt % powdered aluminum polyphosphate foam, and sand according to certain embodiments of the present disclosure.

FIG. 35B shows red kidney beans on the third day grown on watered beds of: cotton, powdered aluminum polyphosphate foam, sand mixed with 0.1 wt % powdered aluminum polyphosphate foam, sand mixed with 1 wt % powdered aluminum polyphosphate foam, sand mixed with 10 wt % powdered aluminum polyphosphate foam, and sand according to certain embodiments of the present disclosure.

FIG. 35C shows red kidney beans on the seventh day grown on watered beds of: cotton, powdered aluminum polyphosphate foam, sand mixed with 0.1 wt % powdered aluminum polyphosphate foam, sand mixed with 1 wt % powdered aluminum polyphosphate foam, sand mixed with 10 wt % powdered aluminum polyphosphate foam, and sand, on the seventh day, according to certain embodiments of the present disclosure.

FIG. 35D shows red kidney beans on the twelfth day grown on watered beds of cotton, powdered aluminum polyphosphate foam, sand mixed with 0.1 wt % powdered aluminum polyphosphate foam, sand mixed with 1 wt % powdered aluminum polyphosphate foam, sand mixed with 10 wt % powdered aluminum polyphosphate foam, and sand according to certain embodiments of the present disclosure.

FIG. 35E shows a side view of red kidney beans on the twelfth day grown on watered beds of: cotton, powdered aluminum polyphosphate foam, sand mixed with 0.1 wt % powdered aluminum polyphosphate foam, sand mixed with 1 wt % powdered aluminum polyphosphate foam, sand mixed with 10 wt % powdered aluminum polyphosphate foam, and sand according to certain embodiments of the present disclosure.

FIG. 35F shows kidney beans grown on watered sand without powdered aluminum polyphosphate foam after two weeks of growth, according to certain embodiments.

FIG. 35G shows kidney beans grown on watered sand with 5 wt % powdered aluminum polyphosphate foam after two weeks of growth, according to certain embodiments of the present disclosure.

### DETAILED DESCRIPTION

Disclosed herein are polyphosphate materials with practical application to bulk materials. The thermal stability and the polyelectrolytic/chelating characters of polyphosphate materials can combine heat resistance and fire resistance of these materials with interesting optical, thermal, and mechanical properties. Disclosed herein are polyphosphate materials with properties based on multivalent interactions of polyphosphate chains with metal ions, charged nanoparticles, or surfaces of other bulk materials. Disclosed herein are methods of making polyphosphate processable into a range of bulk materials including anti-fire coatings, soft materials, adhesives, luminescent solid solutions, and thermally insulating porous materials. For example, by selecting metal cations or combinations of metal cations used in forming polyphosphate materials and methods forming polyphosphate materials, polyphosphate materials can be formed as amorphous materials, plasticized materials, gels, adhesives, films, or foams.

Disclosed herein is a thermal polycondensation of orthophosphate for the synthesis of polycondensation. Potential advantages of utilizing the synthesis disclosed herein include: (i) being free from any reagents and solvents; (ii) the starting material can be inexpensive and non-toxic; (iii) the product polymer can hydrolyze back to the starting material; (iv) the polymerization process generates only water as a side product, and the back reaction (i.e. hydrolysis) requires only water. Disclosed herein are methods to tune properties of polyphosphate with a selection of counter ions (e.g., cations) and to process polyphosphate by both wet and dry processes into desired shapes and morphologies.

Polyphosphate materials disclosed herein are polyelectrolytes with a thermally stable molecular structure, which, in some embodiments, combine heat and fire resistance of polyphosphate materials with interesting optical, thermal, and mechanical properties. As disclosed herein, these properties can be modified using multivalent interactions of polyphosphate chains with metal ions, charged nanoparticles, or surfaces of other bulk materials. For example, a porous monolithic material that includes polyphosphate chains held together with Al³⁺ can have both thermal insulation properties and stability over a wide temperature range from −196 to 800° C. Polyphosphates can be non-flammable, less expensive, more environmentally friendly, and easier to produce and recycle, compared to existing thermal insulating materials. For example, porous material of polyphosphate can be useful for a range of insulation purposes that include the protection of vehicles in aerospace industries and the reduction of thermal energy loss in power industries. In some embodiments, polyphosphate materials disclosed herein can be more processible or can used as adhesives. For example, plasticized polyphosphates can be more processible or can used as adhesives

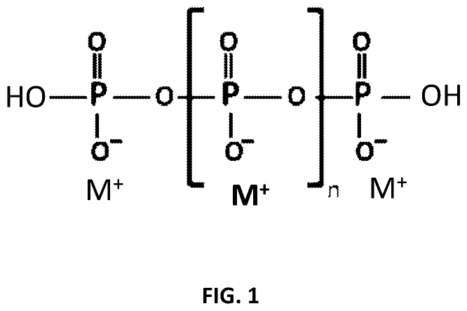

FIG. 1 show an exemplary polyphosphate. FIG. 1 shows an exemplary polyphosphate material with an oxygen-phosphate backbone having n phosphate units. In some embodiments, polyphosphate materials can be polymers comprising several hundred residues of orthophosphate linked by energy-rich phosphoanhydride bonds. In some embodiments, polyphosphate materials can include a polyphosphate polymer chain having a backbone of oxygen-phosphate bonds. In some embodiments, each phosphate unit can include a counterion, e.g., a cation M*. In some embodiments, the polyphosphate polymer chain can be linear. In other embodiments the polyphosphate polymer chain can be branched. In some embodiments, the polyphosphate polymer chains can be crosslinked. In some embodiments, crosslinked polyphosphate materials can include monovalent or multivalent cations.

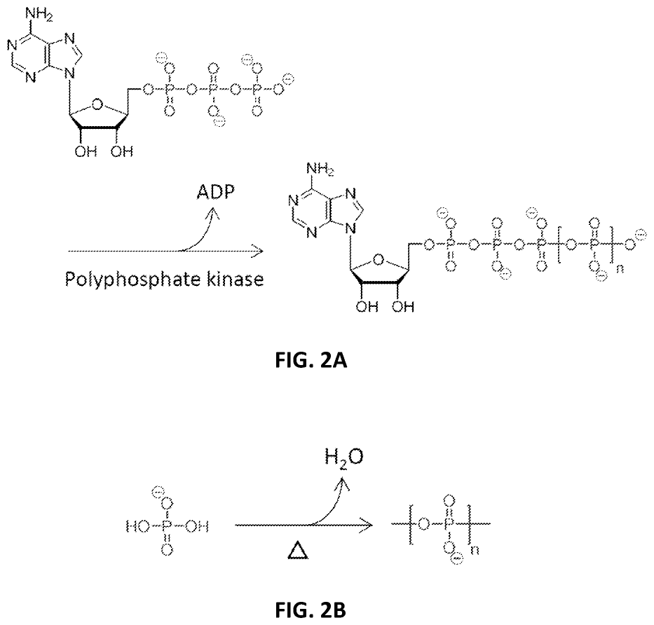

FIGS. 2A-2B show exemplary synthesis of polyphosphate materials. In these schemes, counterions are omitted. For example, as shown in FIG. 2A, biological systems produce polyphosphate via polycondensation of adenosine triphosphate (ATP) with the enzymatic catalysis of polyphosphate kinase (EC 2.7.4.1). In some embodiments, biotic formation of polyphosphates can be synthesized with a degree of polymerization of 750. Additionally, as shown in FIG. 2B, polyphosphate materials can also be synthesized abiotically by a thermally driven polycondensation of orthophosphate and hydrolyzed back to orthophosphate in water via acid or base catalysis. In some embodiments, thermal polycondensation can occur at a temperature above 260° C. In some embodiments, thermal polycondensation forms polyphosphate with a degree of polymerization greater than 1000. In some embodiments, polyphosphate can be hydrolyzed to orthophosphate enzymatically or with acid/base catalysis in water.

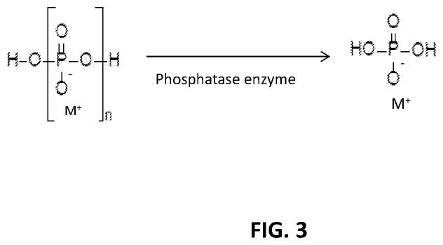

In some embodiments, the polyphosphate materials disclosed herein can withstand high temperatures. In some embodiments, polyphosphate materials are polyphosphate foams that can withstand temperatures of up to 700° C., up to 800° C., or up to 900° C. over at least several hours. In some embodiments, polyphosphate materials are polyphosphate foams that decompose at temperatures of at least 900° C. or at least 1000° C. over a prolonged period of time (e.g., days). In some embodiments, polyphosphate materials can be nonflammable and less prone to react with oxygen in air. In some embodiments, polyphosphates can be used as flame retardants, optionally with additional additives. As shown in FIG. 3, the hydrolysis reaction of ammonium polyphosphate into ammonium dihydrogenphosphate can be catalyzed by phosphatase enzymes to break the oxygen-phosphate (O—P) bond. In this example, the enzyme accelerates the rate of hydrolysis. Alternatively, ammonium polyphosphate can hydrolyze in water spontaneously without an enzyme.

In some embodiments, the polyphosphate materials disclosed herein can also withstand extremely low temperatures. In some embodiments, polyphosphate materials can withstand temperatures corresponding to that of liquid nitrogen. In some embodiments, polyphosphate foams can withstand temperatures of less than 0° C., −50° C., −60° C., −70° C., or −80° C., −100° C., −150° C., −180° C. or a temperature in any range bounded by any value disclosed herein. In some embodiments, polyphosphate materials can withstand temperatures of less than 0° C., −78° C. or −196° C.

In some embodiments, the polyphosphate materials disclosed herein can be biodegradable or have biodegradability properties. For example, enzymes such as exopolyphosphatase (EC 3.6.1.11) catalyze the hydrolysis of polyphosphate into orthophosphate. In some embodiments, as shown in FIG. 3, phosphatases can catalyze a hydrolysis reaction that breaks down polyphosphate materials into biocompatible materials, including phosphates. In some embodiments, the phosphate material biodegrades into a fertilizer. In other embodiments, polyphosphate materials can include cations which are biocompatible.

### I. Synthesis of Polyphosphate Materials

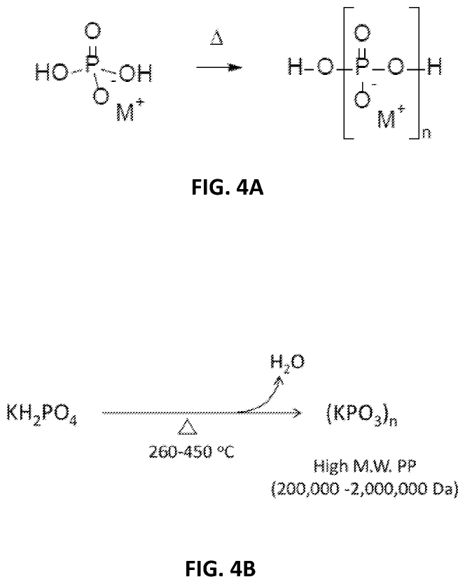

In some embodiments, polyphosphates can be formed using a simple dehydration or condensation reaction, as shown in FIG. 4A. In FIG. 4A, M⁺ represents a cation. At each step, a phosphate unit (e.g., monomer) can be added, and a water molecule is released. This process can be repeated to form a polyphosphate with n units. FIG. 4B shows an exemplary reaction forming high molecular weight potassium polyphosphate. In some embodiments, as shown in FIG. 4B, when polyphosphates with high molecular weights are formed, evaporation of water can drive the reaction. FIG. 4B shows an exemplary reaction forming high molecular weight potassium polyphosphate. As shown in FIG. 3, in some embodiments, this reaction results in a change in temperature of about 260-450° C. and high molecular weight polymers of about 200,000 to about 2,000,000 Da. In some embodiments, molecular weight is controlled by varying time and temperature. In some embodiments, molecular weight affects mechanical stability, thermal stability, and rate of hydrolysis of polyphosphate materials. For example, the longer a chain of a polyphosphate, the more interactions and entanglement there are among chains of the polyphosphate.

In some embodiments, polyphosphate materials can be synthesized using phosphate monomers and cations. In some embodiments, the cation is monovalent, e.g., a monovalent metal. In some embodiments, the cation is divalent, e.g., a divalent metal. In some embodiments, the cation is trivalent, e.g., a trivalent metal such as Fe³⁺. In some embodiments, the cation is tetravalent, e.g., a tetravalent metal such as manganese (Mn⁴⁺), titanium (Ti⁴⁺), and/or Sn⁴⁺. In some embodiments, by selecting the metal cation or combination of metal cations, the properties of the polyphosphate materials can be altered to make these materials more processible or to have desired properties.

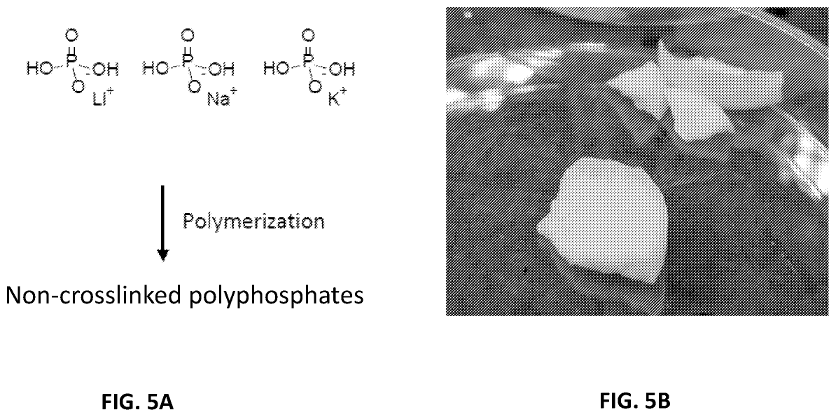

FIGS. 5A-5B show formation of polyphosphate materials using a monovalent cation. FIG. 5A shows the chemical reaction of polymerization to a polyphosphate material from monomers having monovalent cations, for example lithium (Li⁺), sodium (Na⁺), and potassium (K⁺). As shown in FIG. 5A, this polymerization reaction can result in a linear polyphosphate. FIG. 5B shows a photograph of such a polyphosphate material formed using a monovalent cation. In some embodiments, polyphosphates formed using monovalent cations are linear, polymers. In some embodiments polyphosphates formed using monovalent cations can be amorphous and optically transparent. In some embodiments, polyphosphates with monovalent cations are semicrystalline solids. In some embodiments, polyphosphates formed using monovalent cations have low solubility in water. In some embodiments, polyphosphates formed using monovalent cations do not melt in flame. In some embodiments, polyphosphates formed using monovalent cations are difficult process into materials with desirable shapes and sizes. Exemplary monovalent cations include Group I cations and/or those outside of Group I such as gold (Au⁺), silver, and/or copper (Cu⁺). Exemplary monovalent cations include lithium, sodium, potassium, rubidium, cesium, francium, ammonium and combinations thereof. Though, other ions can be used. For example, substituted ammonium cations can be used.

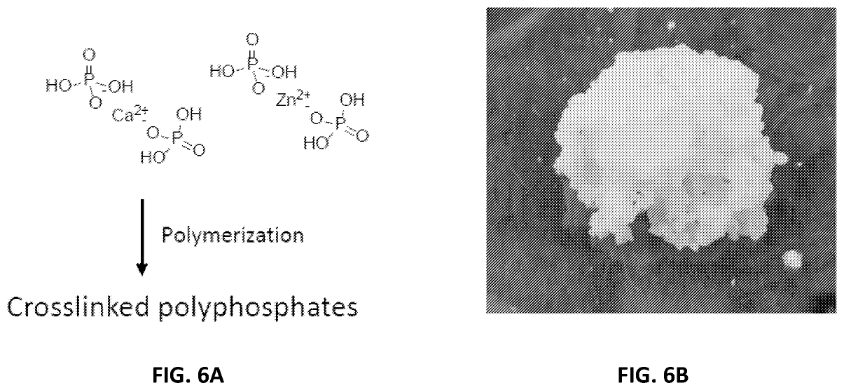

FIGS. 6A-6B show formation of polyphosphate materials using divalent cations. FIG. 6A shows the chemical reaction of polymerization to a polyphosphate material from monomers having divalent cations, for example calcium (Ca²⁺) and zinc (Zn²⁺). As shown in FIG. 6A, this polymerization reaction can result in a non-covalently crosslinked polyphosphate because each divalent cation can interact with more than one phosphate monomer. FIG. 6B shows a photograph of such a polyphosphate material formed using a divalent cation. In some embodiments, polyphosphates formed using divalent cations are semicrystalline solids. In some embodiments, polyphosphates formed using divalent cations have low solubility in water. In some embodiments, polyphosphates formed using divalent cations do not melt in flame. In some embodiments, polyphosphates formed using divalent cations are difficult to process into materials with desirable shapes and sizes. In some embodiments, polyphosphates formed using divalent cations are hard, stable, and heat resistant. Exemplary divalent cations include group II cations. Exemplary divalent cations include beryllium, magnesium, calcium, strontium, barium, radium, zinc, titanium, iron (Fe²⁺), chromium (Cr²⁺), manganese (Mn²⁺), cobalt (Co²⁺), nickel (Ni²⁺), copper (Cu²⁺), cadmium, tin (Sn²⁺), mercury (Hg²⁺), lead (Pb²⁺), and combinations thereof.

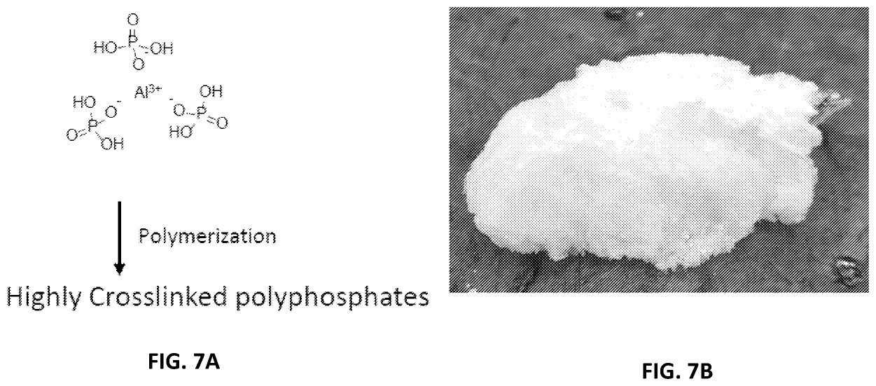

FIGS. 7A-7B show formation of polyphosphate materials using trivalent cations. FIG. 7A shows the chemical reaction of polymerization to a polyphosphate material from monomers having trivalent cations, for example aluminum (Al³⁺). As shown in FIG. 7A, this polymerization reaction can result in a highly crosslinked polyphosphate because each trivalent cation can interact with up to three phosphate monomers. FIG. 7B shows a photograph of such a polyphosphate material formed using trivalent cations. In some embodiments, polyphosphates formed using trivalent cations are lightweight or foam-like. In some embodiments, polyphosphates formed using trivalent cations are thermally insulating. Exemplary trivalent cations include group XIII cations. Exemplary trivalent cations include aluminum, boron, gallium, iron (Fe³⁺), chromium (Cr³⁺), cobalt (Co³⁺), gold (Au³⁺), antimony (Sb³⁺), nickel (Ni³⁺), bismuth (Bi³⁺), manganese (Mn³⁺), and combinations thereof.

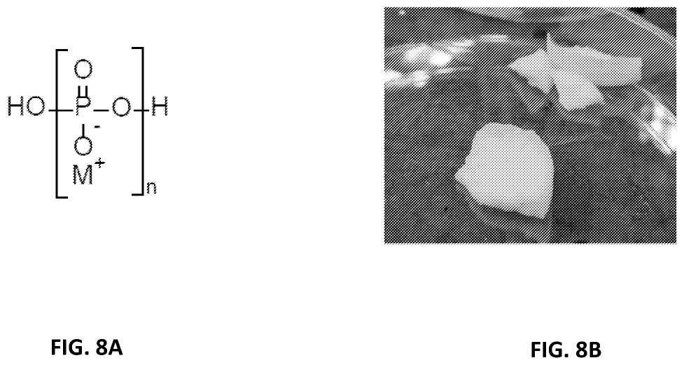

In some embodiments, shown in FIGS. 8A-8B, the polyphosphate material can be synthesized as a homo-polyphosphate. FIG. 8A shows a chemical formula of an exemplary homo-phosphate with n units of one cation (M⁺). FIG. 8B shows a photograph of an exemplary homo-polyphosphate, potassium polyphosphate. In some embodiments, homo-polyphosphates are opaque, hard and brittle, fire resistant, and have a moderate hydrolysis rate in water (e.g., weeks).

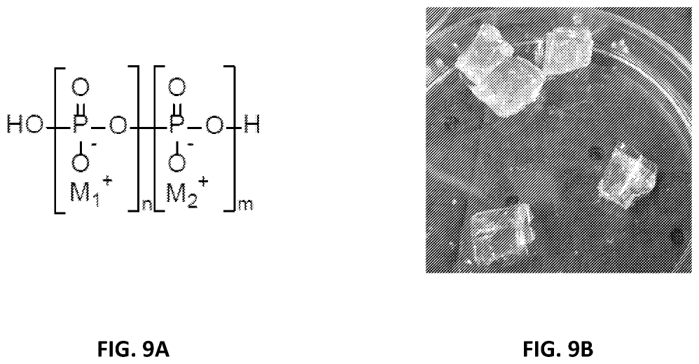

In other embodiments, shown in FIGS. 9A-9B, the polyphosphate material can be synthesized as a mixed-polyphosphate with two or more different cations. In some embodiments, mixed-polyphosphates include at least two, three, or four different cations. FIG. 9A shows a chemical formula of an exemplary mixed-polyphosphate with n units of a first cation (M₁⁺) and m units of a second cation (M₂⁺). FIG. 9B shows a photograph of an exemplary mixed-phosphate, potassium lithium phosphate. In some embodiments, mixed-polyphosphates can be amorphous due to inhibition of crystallization of long polyphosphate polymer chains. In some embodiments, mixed-polyphosphates can be transparent due to inhibition of crystallization of long polyphosphate polymer claims. In some embodiments, the melting point of mixed-phosphates can be lower than homo-polyphosphates so that these materials are melt-processible. In some embodiments, mixed-polyphosphates are hard and brittle, fire resistant, and have fast hydrolysis in water. In some embodiments, mixed-phosphates include monovalent cations, divalent cations, or trivalent cations. In some embodiments, mixed-polyphosphates include a combination of at least two of monovalent cations, divalent cations, or trivalent cations.

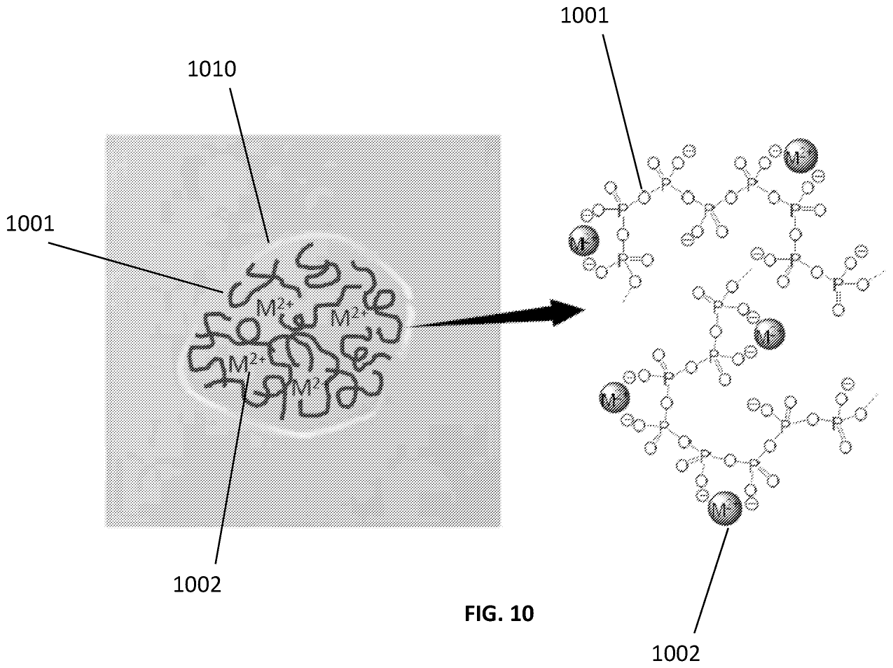

In some embodiments, phosphate materials can be formed by coacervation. Coacervation results in phase separation, as shown in FIG. 10. The coacervate forms droplets 1010 containing the polyphosphate material, with an oxygen-phosphate backbone 1001 and a first metal cation (not shown). Coacervates can be formed when a polyphosphate powder of a first metal cation is added to an aqueous solution to dissolve the polyphosphate powder. In some embodiments, the aqueous solution is a solution of a salt of a second metal cation. In these embodiments, the second cation can then exchange with a portion of the first cation, e.g., partially replacing the first cation, to form a mixed-polyphosphate with both the first cation and the second cation. In some embodiments, this partial exchange causes dissolution of the polyphosphate powder. The exemplary coacervate in FIG. 10 also includes a third cation 1002, added subsequently to the coacervate as a chelating agent. When the solution is cooled, the solution will phase separate into two layers, and the lower layer is a coacervate of polyphosphate. For example, a potassium polyphosphate can be added to a solution of sodium chloride to form a potassium sodium polyphosphate. A coacervate can be formed using any combination of monovalent cations.

In some embodiments, polyphosphate-based coacervates can be used in applications including wastewater treatment, protein purification, food formulation, drug delivery, and cellular mimics. In some embodiments, the polyphosphate-based coacervates can include mixed cations. In some embodiments, the polyphosphate-based coacervates are liquid. It can turn to be a plastic material when isolated and dried.

### II. Polyphosphate Materials

In some embodiments, a polyphosphate material includes an oxygen-phosphate backbone. In some embodiments a polyphosphate material includes molecular groups in addition to oxygen and phosphate in the backbone. In some embodiments, a polyphosphate material includes orthophosphate residues as repeating units. In some embodiments, polyphosphate materials include a polyphosphate polymer chain having a backbone of oxygen-phosphate bonds. In some embodiments, a polyphosphate material includes one or more counterions (e.g., cations). In some embodiments, a polyphosphate material's precursors include phosphate monomers. Exemplary phosphate monomers include dihydrogen phosphate salts.

In some embodiments, a polyphosphate material includes one or more cations as counterions. In some embodiments, the cations include monovalent cations. Exemplary monovalent cations include Group I cations and/or those outside of Group I such as gold (Au⁺), silver, and/or copper (Cu⁺). Exemplary monovalent cations include lithium, sodium, potassium, rubidium, cesium, francium, ammonium, and combinations thereof. In some embodiments, the cations include divalent cations. Exemplary divalent cations include group II cations. Exemplary divalent cations include beryllium, magnesium, calcium, strontium, barium, radium, zinc, titanium, iron (Fe²⁺), chromium (Cr²⁺), manganese (Mn²⁺), cobalt (Co²⁺), nickel (Ni²⁺), copper (Cu²⁺), cadmium, tin (Sn²⁺), mercury (Hg²⁺), lead (Pb²⁺), and combinations thereof. In some embodiments, the cations include trivalent cations. Exemplary trivalent cations include group XIII cations. Exemplary trivalent cations include aluminum, boron, gallium, iron (Fe³⁺), chromium (Cr³⁺), cobalt (Co³⁺), gold (Au³⁺), antimony (Sb³⁺), nickel (Ni³⁺), bismuth (Bi³⁺), manganese (Mn³⁺), and combinations thereof. In some embodiments, the cations include tetravalent cations. Exemplary tetravalent cations include zirconium, silicon, manganese (Mn⁴⁺), titanium (Ti⁴⁺), and combinations thereof. In some embodiments, a polyphosphate includes two or more different cations, for example, two, three, or four cations, or any number of cations in a range bounded by any value disclosed herein. In some embodiments, a polyphosphate includes a combination of monovalent, divalent, trivalent, and tetravalent cations. In some embodiments, the one or more cations include iron. In some embodiment, inclusion of iron ions contributes to magnetic properties of the polyphosphate material. In some embodiments, iron is a counterion of the phosphate material. In other embodiments, iron is added in smaller amounts and dissolved in a melt of polyphosphate.

In some embodiments, a melt of polyphosphate material can dissolve a variety of metal salts. Non-limiting examples of metal salts include salts of multivalent cations, e.g., divalent, trivalent, or tetravalent cations. Non-limiting examples of metal salts include salts of copper, magnesium, chromium, europium, titanium, iron, chromium, manganese, cobalt, nickel, cadmium, tin, mercury, lead, chromium, cobalt, gold, antimony, bismuth, and combinations thereof. Non-limiting examples of metal salts include CuCl₂, MnSO₄, and CrCl₃, EuCl₃, and combinations thereof. In some embodiments, inclusion of metal salts can alter the color of the polyphosphate material. For example, metal cations can contribute color by forming coordination complexes. In some embodiments, inclusion of metal cations, such as fluorescent metal complexes, results in fluorescence of the polyphosphate material. Non-limiting examples of metal salts that result in fluorescence include EuCl₃. Non-limiting examples of metal salts that can result in fluorescence include lanthanoids, e.g., lanthanum (e.g., Ln³⁺), terbium (Tb³⁺), and gadolinium (Gd³⁺).

### A. Plasticized Polyphosphates

In one aspect, a polyphosphate material includes a plurality of polyphosphate chains having a backbone comprising oxygen-phosphate bonds; and two or more cations, wherein the polyphosphate material is amorphous.

In some embodiments, plasticized polyphosphate materials can be formed by incorporating two or more cations to a polyphosphate material. For example, incorporating two or more different cations can inhibit crystallization so that the resultant material becomes more moldable and melt processible. In some embodiments, a plasticized phosphate material is characterized X-ray diffraction (XRD), dynamic mechanical analysis (DMA), differential scanning calorimetry (DSC). For example, a plasticized polyphosphate material can be identified by the absence of distinct peaks in an XRD spectra. As another example, a discontinuous change of properties of the plasticized polyphosphate is observed by using DSC and/or DMA due to glass transition or melting. In these embodiments, incorporating two or more different cations can inhibit crystallization of long polymer chains of the polyphosphate material, resulting in an amorphous material. In some embodiments, incorporating two different cations of different sizes can disrupt order and inhibit crystallization. In contrast, when a polyphosphate material is formed using a single cation (e.g., a homo-polyphosphate), the polyphosphate is typically crystalline or semi-crystalline, hard, brittle, and opaque.

In some embodiments, incorporating a two or more cations can result in the melting point temperature of the mixed-polyphosphate being lower than the melting temperatures of homo-polyphosphates. For example, incorporating the two or more cations can decrease the melting temperature of a polyphosphate material. As a result, such polyphosphate materials can be more processible in a melt at a lower temperature, making them easier to shape into a desired shape. For example, plasticized polyphosphate materials can have a melting temperature less than 300° C. In some embodiments, plasticized polyphosphate materials can have a melting temperature of about 180° C., 190° C., 200° C., 210° C., 220° C., 230° C., 240° C., 250° C., 260° C., 270° C., 280° C., 290° C., 300° C. or any temperature in a range bounded by any value disclosed herein. In some embodiments, plasticized polyphosphate materials can have a melting temperature of about 200 to about 250° C. In comparison, potassium polyphosphate has a melting temperature greater than 1000° C.

In some embodiments, incorporating a two or more cations can result in a lower glass transition temperature of a polyphosphate material. Polyphosphate materials with lower glass transition temperatures can be processed at lower temperatures compared to those with a high transition temperature. In some embodiments, plasticized polyphosphate materials can have a glass transition temperature of about 180° C., 190° C., 200° C., 210° C., 220° C., 230° C., 240° C., 250° C., 260° C., 270° C., 280° C., 290° C., 300° C. or any value in a range bounded by any value disclosed herein. In some embodiments, plasticized polyphosphate materials can have a glass transition temperature of about 200 to about 250° C. In some embodiments, plasticized polyphosphate materials have a glass transition temperature (T_{g}) of about 220° C. In some embodiments, the glass transition temperature depends on the combination of cations or the ratio of cations.

In some embodiments, a plasticized polyphosphate material is non-flammable. For example, plasticized polyphosphates generally do not burn when exposed to flame. For example, a plasticized polyphosphate material is more thermally stable than a carbon-based polymer.

In some embodiments, a plasticized phosphate material can be transparent. In some embodiments, the transparency of a plasticized phosphate material can be controlled by the rate at which the material is cooled from a melt. Above the melting temperature, a polyphosphate material incorporating two or more cations is transparent. In some embodiments, quickly cooling this phosphate material can result in an amorphous, transparent material, for example, because the polyphosphate chains do not have time to crystallize or become ordered and therefore remain amorphous. In some embodiments, cooling a polyphosphate material over a time period on the order of minutes to less than an hour can result in an amorphous, transparent polyphosphate material. In some embodiments, cooling more slowly can result in a translucent or opaque material, for example, if the polyphosphate chains are allowed sufficient time to crystallize or become ordered, rather than forming an amorphous polyphosphate. In some embodiments, the transparency can be controlled by the choice of cations, for example, by choosing a combination of cations that decreases crystallinity or increases disorder of the polyphosphate chains. In some embodiments, transparency depends on the combination of cations or the ratio of cations. For example, a potassium lithium polyphosphate will be transparent even if cooled slowly.

In some embodiments, a plasticized polyphosphate material includes two or more monovalent cations. In some embodiments, a plasticized polyphosphate material includes two or more monovalent cations with different sizes. For example, a plasticized phosphate can include two or more of lithium, sodium, potassium, rubidium, cesium, francium, and ammonium. Non-limiting examples of a plasticized polyphosphate material with monovalent cations include potassium lithium phosphate and potassium lithium phosphate. In some embodiments, a plasticized polyphosphate includes three monovalent cations, e.g., sodium, lithium, and potassium. In some embodiments, at the same ratio, a potassium lithium phosphate will have a greater decrease in crystallinity compared to a potassium sodium phosphate.

In some embodiments, a plasticized polyphosphate material can include multivalent cations. In some embodiments, a plasticized polyphosphate material can include two or more divalent cations. Exemplary divalent cations include group II cations. Exemplary divalent cations include beryllium, magnesium, calcium, strontium, barium, radium, zinc, titanium, iron (Fe²⁺), chromium (Cr²⁺), manganese (Mn²⁺), cobalt (Co²⁺), nickel (Ni²⁺), copper (Cu²⁺), cadmium, tin (Sn²⁺), mercury (Hg²⁺), lead (Pb²⁺), and combinations thereof. In some embodiments, a plasticized polyphosphate material can include two or more trivalent cations. Exemplary trivalent cations include group XIII cations. Exemplary trivalent cations include aluminum, boron, gallium, iron (Fe³⁺), chromium (Cr³⁺), cobalt (Co³⁺), gold (Au³⁺), antimony (Sb³⁺), nickel (Ni³⁺), bismuth (Bi³⁺), manganese (Mn³⁺), and combinations thereof. In some embodiments, a plasticized polyphosphate a combination of cations of different valences, for example, at least two of monovalent cations, divalent cations, or trivalent cations.

In some embodiments, the cations have a ratio of 1:1 mol/mol. In some embodiments, the cations have a ratio of 1:2 mol/mol. In some embodiments, the cations have a ratio of 3:1 mol/mol. For example, in preparing lithium potassium polyphosphate at 500° C., material with a mixing ration (Li/K) in the range of 1:2 mol/mol to 3:1 mol/mol can be amorphous where a cooling rate of the polyphosphate may be taken into account.

In one aspect, a method of forming a polyphosphate material includes adding a polyphosphate powder comprising a first cation to a solution of a salt of a second cation; heating the solution to dissolve the polyphosphate powder; cooling the solution to cause phase separation into an upper liquid layer and a lower liquid layer, wherein the lower liquid layer comprises a coacervate of polyphosphate; and collecting the coacervate.

In some embodiments, plasticized phosphates can be formed by coacervation. Coacervates can form when a polyphosphate powder of a first metal cation is added to a solution of a solution of salt of a second metal cation and heated or boiled to dissolve the polyphosphate powder. The polyphosphate powder can be heated to a temperature of less than or above 100° C. The second cation can then exchange with a portion of the first cation to form a mixed-phosphate with both the first cation and the second cation. The first cation can be potassium and the second cation can be sodium or lithium. Though, this is for example purposes only and should not be construed as a limitation. When the solution is cooled, the solution will phase separate into two layers, and the lower layer is a coacervate of polyphosphate. For example, a potassium polyphosphate can be added to a solution of sodium chloride to form a potassium sodium phosphate. In some embodiments, the coacervate can be dried to form a waxy, plasticized material. In some embodiments, the dried coacervate can be ground into a powder.

In one aspect, a method of forming a polyphosphate material includes providing a first phosphate monomer comprising a first cation; providing a second phosphate monomer comprising a second cation; heating the first phosphate monomer and second phosphate monomer to form a liquid; and cooling the liquid to form an amorphous polyphosphate material. The amorphous polyphosphate material can be dissolved into water. Further, the solution can be gelled by adding a crosslinking material.

In some embodiments, plasticized phosphates can be formed by heating a mixture of a first monomer having a first metal cation (e.g., a metal dihydrogen phosphate) and a second monomer having a second metal cation (e.g., a metal dihydrogen phosphate) to form a liquid (e.g., a melt). Non-limiting examples of monomers include LiH₂PO₄, NaH₂PO₄, and KH₂PO₄. In some embodiments, the mixture is heated at a temperature between 350° C. and 1000° C. In some embodiments, heating at a higher temperature results in a shorter reaction time. In some embodiments, the mixture is heated at a temperature of about 350° C., 400° C., 450° C., 500° C., 550° C., 600° C., 650° C., 700° C., 750° C., 800° C., 850° C., 900° C., 950° C., 1000° C., or any value in a range bounded by a value disclosed herein. In some embodiments, the mixture is heated at a temperature of 1000° C. In some embodiments, the mixture is heated in an oven or by a flame. This liquid can be cooled to form a solid polyphosphate material. In some embodiments, a this solid can be ground to a powder.

In some embodiments, a polyphosphate powder with two or more cations can be mixed with metal salt and heated to a transparent liquid to dissolve additional metal salts. Non-limiting examples of metal salts include salts of copper, magnesium, chromium, europium, iron, titanium, chromium, manganese, cobalt, nickel, tin, mercury, lead, chromium, cobalt, gold, antimony, bismuth, and combinations thereof. Non-limiting examples of metal salts include CuCl₂, MnSO₄, and CrCl₃, EuCl₃, Fe₂(SO₄)₃, and combinations thereof. In some embodiments, inclusion of metal salts can alter the color of the polyphosphate material. For example, metal cations can contribute color by forming coordination complexes. In some embodiments, inclusion of metal cations results in fluorescence of the polyphosphate material. Non-limiting examples of metal salts that result in fluorescence include EuCl₃. Non-limiting examples of metal salts that can result in fluorescence include lanthanoids, e.g., lanthanum (e.g., Ln³⁺), terbium (Tb³⁺), and gadolinium (Gd³⁺).

In some embodiments, a plasticized polyphosphate material is a polyphosphate gel. In some embodiments, addition of multivalent cations or charged particles to an aqueous solution of a polyphosphate can cause formation of a polyphosphate hydrogel. In some embodiments, a polyphosphate gel can be formed by placing a polyphosphate material of a first cation into a solution of a salt of a second cation. For example, a polyphosphate powder of a first metal cation can be added to a solution of a solution of salt of a second metal cation and boiled to dissolve the polyphosphate powder. The cations can exchange such that the polyphosphate material is a mixed-polyphosphate including both the first cation and the second cation, and the solution of the polyphosphate can gel when mixed with crosslinking material. In some embodiments, the polyphosphate gel can be crosslinked using charged particles, for example, by mixing the polyphosphate coacervate with a dispersion of charged particles in water and mixing to form a gel, with the metal charged particles acting as crosslinks. In some embodiments, a gel can be formed by adding charged particles to an aqueous solution of polyphosphate, with charged particles acting as crosslinks. In some embodiments, charged particles form crosslinks via electrostatic interaction with the polyphosphate material. For example, a positively charged particle can interact with the negatively charged polyphosphate backbone. Non-limiting examples of charged polyelectrolytes include metal oxide nanoparticles, dendrimers (e.g., dendrimers with ammonium groups), and chitosan. Non-limiting examples of metal oxide nanoparticles include zinc oxide, titania, and combinations thereof.

In some embodiments, plasticized polyphosphate materials can be used as an adhesive. In some embodiments, a polyphosphate coacervate or polyphosphate solution can be used as an adhesive. In these embodiments, the coacervate or polyphosphate solution can be heated to remove excess water and form an adhesive. In some embodiments, when a plasticized polyphosphate is heated, it forms a viscous fluid. This fluid can be applied to two substrates to adhere them together. Once cooled, the plasticized polyphosphate material forms a glue or adhesive. In some embodiments, this adhesive is thermoplastic, rather than thermoset, and can come apart when heated again, for example at a temperature above the melting temperature, or dipped in water. In some embodiments, a plasticized polyphosphate can be used as an adhesive for glass, metal, ceramic, paper, or wood materials. In some embodiments, a plasticized polyphosphate can be used as an adhesive for a material that is capable of forming coordination, electrostatic and/or hydrogen bonds. In some embodiments, a plasticized polyphosphate can be used as an adhesive between two different materials, for example glass and ceramic.

In some embodiments, plasticized polyphosphate materials can form films. In some embodiments, films can be formed by placing a plasticized polyphosphate material on a heat press and applying pressure at a temperature greater than T_{g}. In some embodiments, these films can be transparent. In some embodiments, films can be formed by drying a concentrated solution of polyphosphate on a substrate, e.g., a Teflon substrate. In some embodiments, films can be formed by spin coating a substrate, e.g., by spin coating a silicon wafer.

In some embodiments, plasticized polyphosphate materials can be made hydrophobic by exchanging cations of the polyphosphate material with hydrophobic cations, e.g., tetraalkyl ammonium ions, in solution. For example, an aqueous solution of a polyphosphate with two cations (e.g., sodium-potassium polyphosphate) can be added to an aqueous solution of hydrophobic cations. In these embodiments, ion exchange can result in precipitation of a hydrophobic polyphosphate material. In some embodiments, hydrophobic plasticized polyphosphate materials can be made by exchanging alkali metal ions with substituted ammonium ions. In some embodiments, a hydrophobic cation is a cation that includes a hydrocarbon. Non-limiting examples of hydrophobic cations include mono-, di-, tri-, tetra-substituted ammonium cations and their perfluoro analogs. Non-limiting examples of hydrophobic cation include substituted ammonium (e.g., cetyltrimethylammonium, alkylammoniums), pyrrolium, imidazolium cations, and combinations thereof.

In some embodiments, a plasticized polyphosphate coating can be formed using a coacervate or a polyphosphate solution. For example, by forming a plasticized polyphosphate coating from a coacervate or polyphosphate solution, the coating can be applied at a lower temperature. This can allow coating of temperature sensitive materials, e.g., paper or wood. In some embodiments, a plasticized polyphosphate material can be applied by spray coating. In other embodiments, a plasticized polyphosphate coating can be applied using a melt, for example to apply a coating to glass, metal, or ceramic or other heat-stable materials. In some embodiments, incorporation of two or more cations in a plasticized polyphosphate material allows coating from a melt at lower temperatures.

In some embodiments, the plasticized polyphosphate materials disclosed herein can be used in various applications, for example, adhesives, fire-proof coatings, solid state Li-ion conductors, electronic coatings, polymer solvents, shielding materials from oxygen, and transparent films.

### B. Polyphosphate Foams

In one aspect, a polyphosphate material includes a plurality of polyphosphate chains having a backbone comprising oxygen-phosphate bonds; and one or more multivalent cations forming crosslinks between the polyphosphate chains, wherein the polyphosphate material is porous.

In some embodiments, polyphosphate foams can be formed by incorporating one or more multivalent cations. Multivalent cations can form crosslinks between phosphate chains because they can interact with more than one phosphate unit. When polyphosphate precursors are heated, water molecules formed by the condensation reaction evaporate, forming bubbles or voids, and these voids can be stabilized by crosslinks formed by the multivalent cations to form pores.

In some embodiments, polyphosphate foams include a porous structure dominated by macropores. In some embodiments, polyphosphate foams include pores with diameters on the order of about a few micrometers. In some embodiments, polyphosphate foams include pores with diameters greater than 1p m. In some embodiments, polyphosphate foams include pores with diameter of 1 μm, 2 μm, 3, μm, 4 μm, 5 μm, 10 μm, 15 μm, 20 μm, 25 μm, 30 μm, 35 μm, 40 μm, 45 μm, 50 μm, 55 μm, 60 μm, 70 μm, 80 μm, 90 μm, 100 μm, or any value in a range bounded by any value disclosed herein. In some embodiments, the pores can form a three-dimensional, interconnected network. For example, fluids can permeate through the interconnected network formed by the pores. In some embodiments aqueous solutions can permeate through the interconnected network. In some embodiments, organic solvents can permeate through the interconnected network. In some embodiments, a polyphosphate material can store such fluids in the pores.

In some embodiments, the polyphosphate material is a polyphosphate foam. In some embodiments, the polyphosphate foam can have low density. In some embodiments, polyphosphate foams have a density of less than 0.15 g/cm³. In some embodiments, the density is less than 0.10, less than 0.05, less than 0.01 g/cm³ or a density in any range bounded by any value disclosed herein. In some embodiments, the polyphosphate material can have high porosity. In some embodiments, the porosity is at least 70%, at least 80%, at least 90%, at least 95% or a porosity in any range bounded by any value disclosed herein. In some embodiments, the polyphosphate material can have a surface area of at least 0.5 m²/g.

In some embodiments, polyphosphate foams can be semi-crystalline. In some embodiments, incorporating a second cation to a polyphosphate foam can decrease crystallinity.

In some embodiments, polyphosphate foams include one or more multivalent cations. In some embodiments, polyphosphate foams include cations with a valency of at least three. In these embodiments, including a cation with a valency of at least three can allow formation of crosslinks that stabilize voids during synthesis. In some embodiments, the cations include trivalent cations. Exemplary trivalent cations include group XIII cations. Exemplary trivalent cations include aluminum, boron, gallium, iron (Fe³⁺), chromium (Cr³⁺), cobalt (Co³⁺), gold (Au³⁺), antimony (Sb³⁺), nickel (Ni³⁺), bismuth (Bi³⁺), manganese (Mn³⁺) and combinations thereof. In some embodiments, the cations include tetravalent cations. Exemplary tetravalent cations include zirconium, silicon, manganese (Mn⁴⁺), titanium (Ti⁴⁺), and combinations thereof.

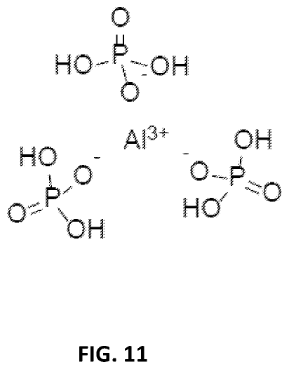

In some embodiments, aluminum polyphosphate foams can be synthesized using monomers of aluminum dihydrogenphosphate and/or iron (III) dihydrogen phosphate. FIG. 11 shows the chemical formula of an aluminum dihydrogen phosphate. Aluminum dihydrogenphosphate can also be used as a precursor for synthesis of microwave absorbing silicon carbide (SiC) fiber-reinforced SiCmatrix composites, aluminum doped hydroxyapatite crystals, phosphate insulating coating to improve the corrosion resistance of silicon steel. When aluminum dihydrogenphosphate is heated slowly during synthesis, formation of voids is minimized as water is expelled from the material during the dehydration reaction. In contrast, when dihydrogenphosphate is heated rapidly, voids can form, and a porous material or foam can be formed.

In one aspect, a method of forming a polyphosphate material includes providing a mixture of a phosphate monomer comprising a multivalent cation; and heating the mixture to form a polyphosphate foam.

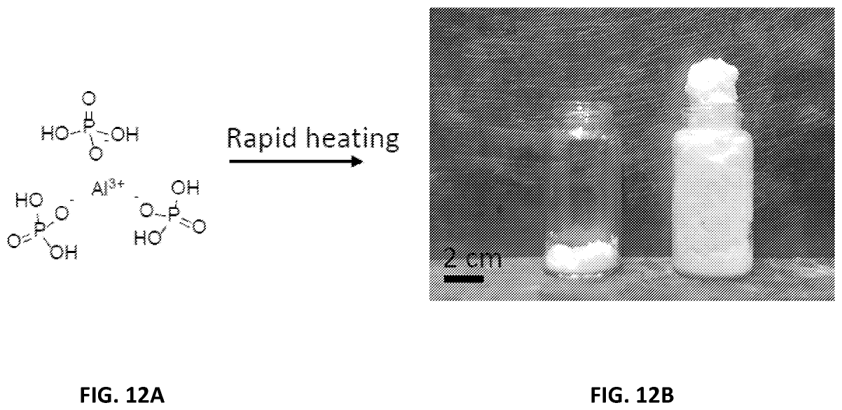

In some embodiments, phosphate precursors can be heated rapidly to form polyphosphate foam. FIG. 12A shows a chemical reaction of rapid heating of an exemplary phosphate monomer with a multivalent cation, aluminum dihydrogen phosphate. In some embodiments, when polyphosphate materials are heated rapidly during synthesis, the water molecules formed by the hydration reaction can evaporate quickly, forming bubbles or voids in the polyphosphate material. In some embodiments, a polyphosphate foam forms by direct heating using a torch (e.g., for a period of a few seconds to up to a minute) where the temperature of the torch is over 500° C. In some embodiments, a polyphosphate foam forms by heating a mixture of monomer at a temperature greater than 500° C. In some embodiments, a polyphosphate foam forms by heating at a temperature between 1000° C. and 2500° C. In some embodiments, polyphosphate foam forms by heating at a temperature of 1000° C., 1100° C., 1200° C., 1300° C., 1400° C., 1500° C., 1600° C., 1700° C., 1800° C., 1900° C., 2000° C., 2100° C., 2200° C., 2300° C., 2400° C., 2550° C., or at any temperature in a range bounded by any value disclosed herein. In contrast, when polyphosphate materials are heated slowly, evaporating water has time to leave the material and formation of voids is minimized. In some embodiments, polyphosphate material includes a high degree of crosslinking which can prevent voids from collapsing. In some embodiments, a high degree of crosslinking can be achieved using a multivalent cation, e.g., a divalent, trivalent, or tetravalent cation. In some embodiments, a high degree of crosslinking can be achieved using aluminum.

In some embodiments when polyphosphate materials are heated rapidly during synthesis, the resulting material can have low density, high porosity, or both. In some embodiments, porosity can be controlled using pressure, geometry, or both. For example, pressure of the air being blown onto the polymer surface can control macroscopic homogeneity of the material (e.g., to avoid large, mm-sized voids). For example, pressure of the air can cause large voids to collapse so that they do not remain in the material. In another example, geometry (e.g., the powder grind size) of the monomer used for polymerization influences the spatial homogeneity of the polycondensation process (e.g., how quickly and how easily can bubbles escape from the material). In some embodiments, the polyphosphate material is a polyphosphate foam. FIG. 12B shows an aluminum dihydrogenphosphate powder before (left) and after (right) heating, showing significant increase in volume (scale bar 2 cm). In some embodiments, much of this volume increase occurs via formation of voids, and the material on the right is a foam

In some embodiments, polyphosphate foams can be formed by a layer-by-layer process. In a layer-by-layer process, a powder of polyphosphate precursor with a multivalent cation (e.g., a monomer of phosphate with a multivalent cation) can be deposited on a surface and heated. In some embodiments the powder can be heated at a temperature between about 800° C. and about 2000° C. In some embodiments, polyphosphate foam forms by heating at a temperature of 800° C., 900° C., 1000° C., 1100° C., 1200° C., 1300° C., 1400° C., 1500° C., 1600° C., 1700° C., 1800° C., 1900° C., 2000° C., or at any temperature in a range bounded by any value disclosed herein. In some embodiments, a layer of powder can be deposited using a spray gun. In some embodiments, a layer of powder can be deposited using a shaker. In some embodiments, a filter is used to deposit powder based on particle size. In some embodiments, a layer of powder can be heated using a gas torch, e.g., using a MAPP torch with a flame temperature of about 2000° C. In some embodiments, a layer of powder can be heated in an oven, e.g., at temperatures of at least about 800° C. This process of depositing and heating can be repeated to form a monolithic block of polyphosphate foam layer by layer. In some embodiments, a layer can be 0.3-0.5 mm. In some embodiments, the resulting monolith can be cut into a desired shape, e.g., using a razor or a laser cutter. In some embodiments, forming a polyphosphate foam layer by layer can prevent formation of large voids remaining inside the material and thereby improve mechanical stability of the monolith. In some embodiments, a layer-by-layer process prevents formation of large voids because voids are limited by the thickness of the layers. For example, in a layer-by-layer process, the voids can have a size much less than the thickness of the layer. In some embodiments, a layer-by-layer process prevents large defects, e.g., large voids, from remaining in the material. For example, in some embodiments, voids do not remain in the material because they can escape as each layer is deposited. In some embodiments, a layer-by-layer process improves geometric homogeneity of the monomer reagent used.

In some embodiments, the polyphosphate foams disclosed herein can withstand high temperatures without formation of cracks or collapse of internal pores. In some embodiments, polyphosphate foams can withstand temperatures of up to 800° C., up to 900° C., or up to 1000° C. or any temperature in any range bounded by any value disclosed herein. In some embodiments, a polyphosphate foam can withstand a temperature of up to about 3000° C. for a short period of time (e.g., minutes to hours). In some embodiments, polyphosphate foams decompose at temperatures of at least 900° C. or at least 1000° C. over a prolonged period of time (e.g., days). In some embodiments, polyphosphate materials can withstand high temperatures because the O—P bond in the backbone of polyphosphate materials is stable at high temperature. In some embodiments, polyphosphates can be used as flame retardants, optionally with additional additives such as ammonium phosphate.

In some embodiments, the polyphosphate foams disclosed herein can also withstand extremely low temperatures. In some embodiments, polyphosphate foams can withstand temperatures corresponding to that of liquid nitrogen. In some embodiments, polyphosphate foams can withstand temperatures of less than 0° C., −50° C., −60° C., −70° C., or −80° C., −100° C., −150° C., −180° C. or any temperature in any range bounded by any value disclosed herein. In some embodiments, polyphosphate foams can withstand temperatures of less than 0° C., −78° C. or −196C. In some embodiments, polyphosphate foams can withstand temperatures of less than −196° C.

In some embodiments, the polyphosphate foams disclosed herein have excellent mechanical properties. In some embodiments, phosphate materials can support over 250 times their own weight. In some embodiments, polyphosphate foams have a compressive strength of 100 to 200 kPa. In some embodiments, polyphosphate materials can sustain their mechanical properties across a range of temperatures, e.g., between room temperature and 600° C., as measured by dynamic mechanical analysis.

In some embodiments, polyphosphate foams can be stable in water. In some embodiments, polyphosphate foams do not degrade after weeks in water. The stability in water can be due to several factors, including the crystallinity or structural packing of the material, and the electrostatics (e.g., multivalency of the cation). In some embodiments, a passivation layer can form on the surface of a polyphosphate foam to protect the material from hydrolysis.

In some embodiments, polyphosphate foams can have a low thermal conductivity. In some embodiments, the thermal conductivity of a polyphosphate foam is about 0.01-0.05 W. m⁻¹·K⁻¹.

In some embodiments, the polyphosphate foams disclosed herein can be good thermal insulators because they almost nullify heat transfer. First, in some embodiments, polyphosphate foams disclosed herein can reduce conduction of heat, for example, because they are highly porous and composed mostly of insulating gas. Second, in some embodiments, polyphosphate foams disclosed herein can reduce convection, for example, because the microstructure, including high porosity, prevents net gas movement. Super-insulating materials with low thermal conductivities are important for high temperature applications. Porous materials can have low thermal conductivity while also being ultralight. Porous materials can be good thermal insulators because they almost nullify two of the three methods of heat transfer: (1) conduction because they are mostly composed of insulating gas, (2) and convection because the porous microstructure prevents net gas movement. While the process and materials used to make super-insulating, porous materials are often expensive, the process and material to make polyphosphate foams is inexpensive.

In some embodiments, the polyphosphate foams disclosed herein have advantages over silica aerogels. Silica aerogels are synthesized by using a sol-gel process. Ethanol is mixed with a silicon alkoxide, such as tetramethoxysilane (TMOS), tetraethoxysilane (TEOS), and polyethoxydisiloxane (PEDS). The solution of silica is mixed with a catalyst and allowed to gel and form particles of silicon dioxide. The oxide suspension begins to undergo condensation reactions linking the dispersed colloidal particles. These reactions generally have moderately slow reaction rates, and as a result either acidic or basic catalysts are used to improve the processing speed. Basic catalysts tend to strengthen the material to prevent pore collapse during drying. Finally, during the drying process of the aerogel, the liquid surrounding the silica network is carefully removed and replaced with air (commercially, supercritical CO₂ is used). Exemplary advantages of polyphosphate materials are as follows. First, for example, polyphosphate materials can have lower material costs than silica aerogels. Second, for example, while silica aerogels require an expensive process that includes freeze-drying, polyphosphate materials can be made using a low-cost process. Third, while silica aerogels use a freeze-drying process that takes days, polyphosphate materials can be made within seconds or minutes. Fourth, for example, while silica aerogels have only intermediate temperature resistance, polyphosphate materials have high temperature resistance and, in some embodiments, can withstand up to 2000° C. for minutes or withstand up to 900° C. for days. Fifth, for example, while silica aerogels are hydrophilic and have only intermediate water resistance, polyphosphate materials have high water resistance and, in some embodiments, can withstand for a month in water. Sixth, while silica aerogels are not biodegradable, polyphosphate materials can be biodegradable, and in some embodiments, degrade into biocompatible components.

In some embodiments, the polyphosphate foam can be a composite material that includes additional components. In some embodiments, additional components include nanomaterials. Exemplary nanomaterials include metal oxide nanoparticles, metal nanoparticles, metal nanorods, carbon fibers, clays, organic hybrids, silica, borosilicate, borate containing materials, and combinations thereof. Exemplary metal oxide nanoparticles include zirconia, titania, silica, alumina, zinc oxide, magnesium oxide, iron oxide, copper oxide, and combinations thereof. Exemplary metal nanoparticles or metal nanorods include gold nanoparticles, gold nanorods, silver nanoparticles, silver nanorods, copper nanoparticles, copper nanorods, and combinations thereof. Exemplary clays include Laponite, montmorillonite, kaolinite, and combinations thereof. In some embodiments, the additional components include metal oxides. Exemplary metal oxides include zirconia, titania, silica, alumina, zinc oxide, magnesium oxide, iron oxide, copper oxide, and combinations thereof.

In some embodiments, the polyphosphate foams disclosed herein can be used in various applications, for example, insulating materials, infrared masking materials, catalyst supports, and air purification, chemical adsorbers for cleaning up spills, fire-proof coatings, water purification, porous electrodes, or trapping space dust particles.

### C. Fertilizers

In some embodiments, polyphosphate materials disclosed herein can be used as fertilizers. The transformation between monomer (orthophosphate) and polymer (polyphosphate) is fully reversible and free from side products except water. The simplicity of the polymerization and depolymerization processes can be useful in a “circular economy,” e.g., as fertilizers. For example, as shown FIG. 3, phosphatases can catalyze a hydrolysis reaction that breaks down polyphosphate materials into biocompatible materials, including phosphates. Alternatively, polyphosphate materials can hydrolyze in water spontaneously without enzymes. In some embodiments, the phosphate material biodegrades into a fertilizer. In some embodiments, after use, polyphosphates can be reused as fertilizers.

### EXAMPLES

Certain embodiments will now be described in the following non-limiting examples.

### I. Reversible Transformation Between Monomer and Polymer

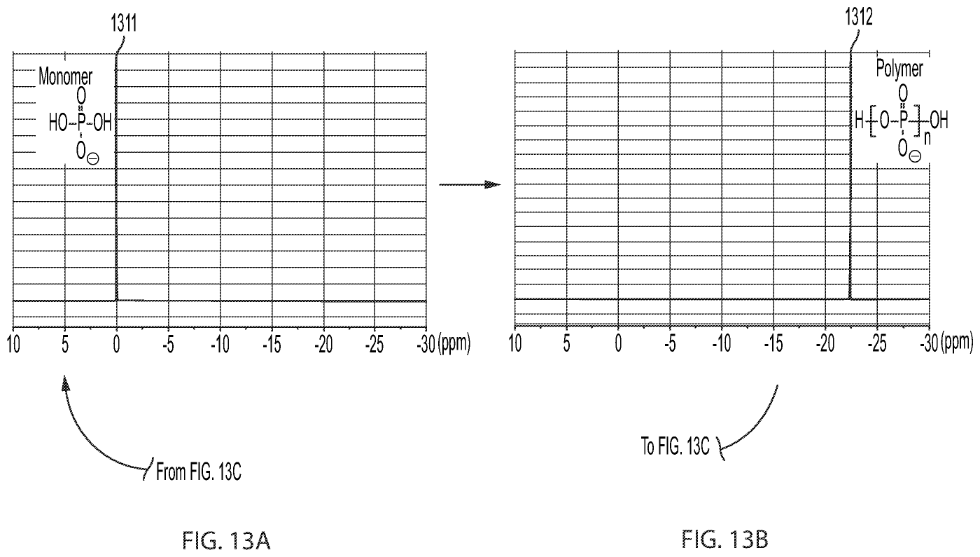

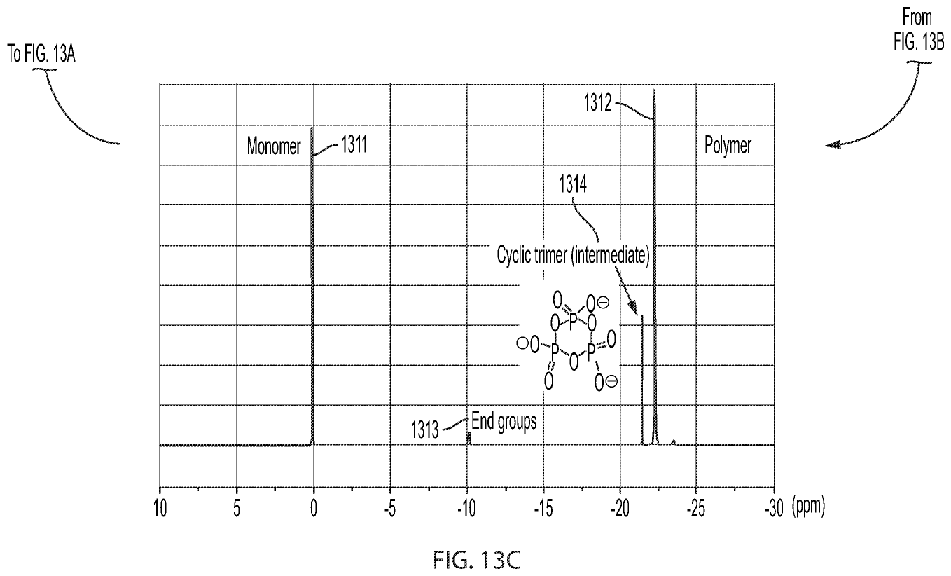

Thermal polycondensation of potassium dihydrogen phosphate (KH₂PO₄) was performed. FIG. 13A shows the ³¹P NMR of potassium dihydrogen phosphate monomer with the monomer peak 1311. After thermal polycondensation, resulting white solids of potassium polyphosphate (K—PP) were insoluble with water alone but dissolved in water with addition of sodium chloride via ion exchange. The average molecular weight of the resulting polyphosphate should be higher than a million. Indeed, as shown in FIG. 13B, the polymer peak 1312 was observed after polycondensation, but it was not possible to observe end-group signals of the polyphosphate by ³¹P NMR. As shown in FIG. 13C, heating the NMR sample in D₂0 at 80° C. for 24 hours promotes hydrolysis of PP with emergence of the signals of orthophosphate, terminal phosphate groups of polyphosphate 1313, and trimetaphosphate 1314. Continued heating of the solution at 80° C. for 3 days led to full conversion of polyphosphate back to orthophosphate monomer, as shown in FIG. 13A. This hydrolysis is autocatalytic due to acidic nature of hydrolysates of polyphosphate; the solution of polyphosphate was initially neutral but became more acidic (down to pH-4.5) as the hydrolysis progressed because the hydrolyzed product (KH₂PO₄) is acidic. These results confirm that the transformation between monomer (dihydrogen phosphate) and polymer (polyphosphate) is reversible. It progresses by taking in and out of water without need of any enzymes or chemical reagents. Such simple reactions would be feasible even on the prebiotic Earth. Further, these results may be applied as a fertilizer. For instance, the hydrolysis products (e.g., phosphate monomers) are water soluble, which can be used by plants to help them grow. Additionally, polyphosphate is known to be biodegradable. Some enzymes can accelerate the depolymerization (i.e., hydrolysis) process to decompose polyphosphate-based materials.

### II. Plasticized Polyphosphates

### A. Preparing Amorphous Polyphosphates

To prepare amorphous polyphosphates, an equimolar mixture of sodium dihydrogen phosphate monohydrate (1.37 g, 10 mmol) and potassium dihydrogen phosphate (1.36 g, 10 mmol) was placed in a ceramic crucible and heated at 500° C. for 5 h in an oven to yield a quantitative amount of sodium-potassium (1:1) polyphosphate (Na/K—PP) as a colorless liquid. The liquid was taken out of the oven and cooled to room temperature to give a colorless solid. The solid was ground into a fine powder.

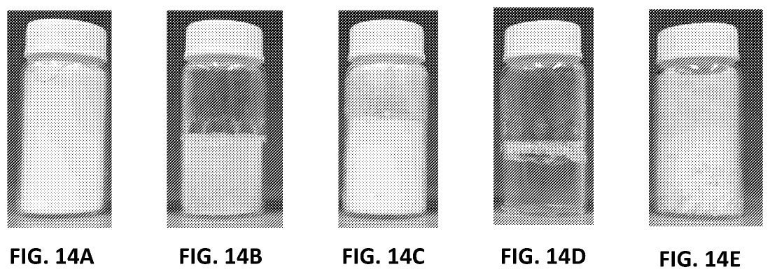

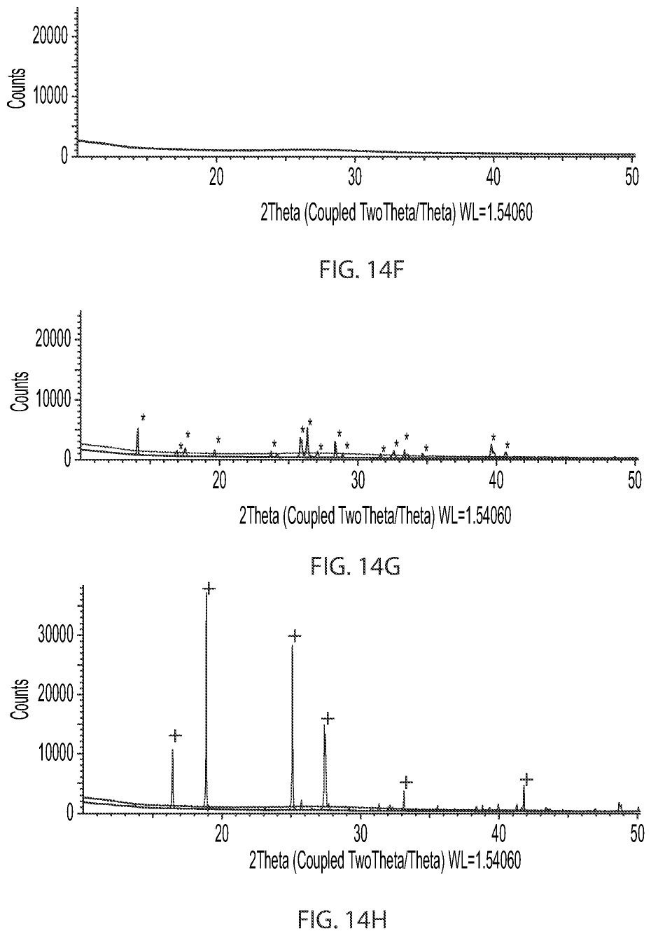

FIGS. 14A-14E show preparation of polyphosphates using different monomers in combination. In this example, the monomers are in the form of a powder. FIGS. 14A-14E show the resulting polyphosphate solid materials that may be in the form of solid blocks that can be grinded into powder forms for structural characterization (e.g., using XRD). NaH₂PO₄, NaH₂PO₄/KH₂PO₄ (1:1 mol/mol), KH₂PO₄, KH₂PO₄/LiH₂PO₄ (1:1 mol/mol), and LiH₂PO₄ were polymerized at 500° C. for 5h and cooled to room temperature to give solids of sodium polyphosphate (Na—PP, FIG. 14A), sodium-potassium polyphosphate (Na/K—PP, FIG. 14B), potassium polyphosphate (K—PP, FIG. 14C), lithium-potassium polyphosphate (Li/K—PP, FIG. 14D), and lithium polyphosphate (Li—PP, FIG. 14E), respectively. FIGS. 14F-14H show powder X-ray diffractograms of Li/K—PP (FIG. 14F), K—PP (FIG. 14G), and Li—PP (FIG. 14H). The diffractograms for K—PP (FIG. 14G) and Li—PP (FIG. 14H) show peaks (indicated by a*for K—PP and by a+ for Li—PP), indicating these materials are semicrystalline, but the diffractograms for Li/K (FIG. 14F) has no peaks, indicating that this material is amorphous. Differential scanning calorimetry (DSC) and dynamic mechanical analysis (DMA) analyses indicate that the melting temperature of the amorphous Li/K—PP material is about 220° C.

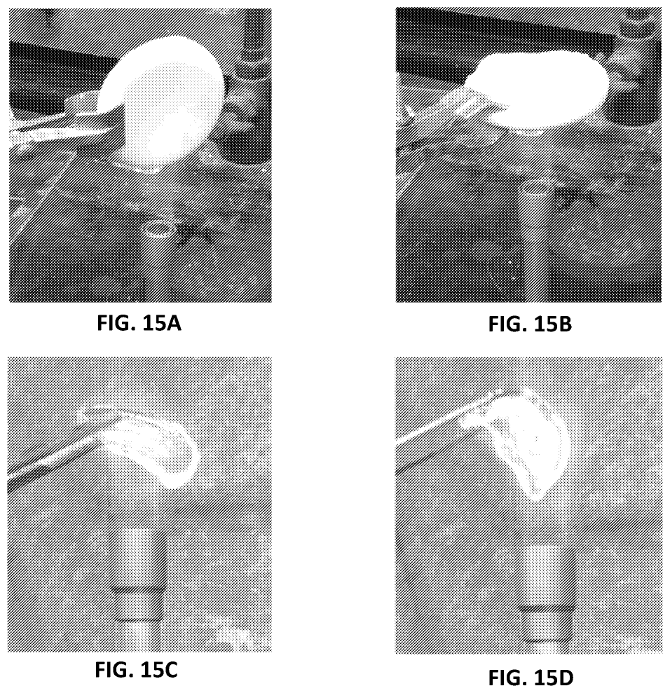

FIGS. 15A-15D show a comparison of the thermal response of amorphous, plasticized polyphosphate materials bearing two different cations to polyphosphate materials bearing a single cation. When metal dihydrogen phosphates are polymerized alone, it generally gives rise to semi-crystalline products that are thermally stable and often insoluble in water. In contrast, when a mixture of such monomers is polymerized, the mixture of different counter ions hinders crystallization of polyphosphate, forming less crystalline material that is processible in melt at a lower temperature. FIGS. 15A-15B shows a white solid block of potassium polyphosphate (K—PP) produced via thermal polymerization of KH₂PO₄ that was neither burned nor softened in the flame of a gas burner. In contrast, as shown in FIGS. 15C-15D, a translucent solid block of sodium-potassium polyphosphate (Na/K—PP) produced from an equimolar mixture of NaH₂PO₄ and KH₂PO₄ was not burned, but readily softened and deformed in the flame. This indicates a lower melting temperature and that plasticized polyphosphate materials formed with two or more cations can be processed at lower temperatures.

### B. Dissolution of Metal Salts in Polyphosphate Materials

Metal salts were dissolved in polyphosphate melts. In one example, 2.4 g of the Na/K—PP powder and 170 mg (1.00 mmol) of CuCl₃·2H₂O were placed in a glass vial and mixed with a vortex mixer. The mixture was heated with flame with gentle shaking until the solids melted and became a transparent liquid. Cooling the melt to room temperature furnished a blue-colored transparent solid.

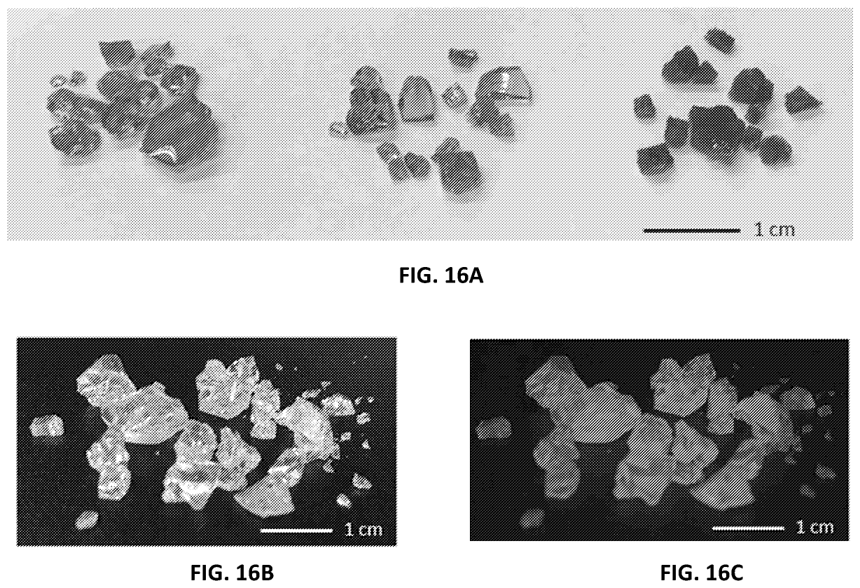

FIGS. 16A-16C show exemplary sodium potassium polyphosphates with dissolved metal salts. The polyphosphate melt dissolves a variety of metal salts and solidifies upon cooling. FIG. 16A shows exemplary sodium potassium polyphosphates with dissolved metals that result in different colors. In this example, each sodium potassium polyphosphate material includes 5% mol of the metal salt (as to repeat unit of polyphosphate). Addition of CuCl₂ salt resulted in a blue color (left), addition of MnSO₄ salt resulted in a pink color (middle), and addition of CrCl₃ salts resulted in a green color (right). FIGS. 16B-16C show sodium potassium polyphosphate materials with 1% mol EuCl₃. As shown in FIG. 16B, sodium potassium polyphosphate materials with EuCl₃ are colorless. However, as shown in FIG. 16C, sodium potassium polyphosphate materials with EuCl₃ emit red fluorescence when irradiated at 365 nm.

### C. Polyphosphate Coacervates

To prepare a polyphosphate coacervatepotassium dihydrogen phosphate (100 g) was placed in a ceramic crucible and heated at 500° C. for 5 h in an oven to yield a quantitative amount of potassium polyphosphate (K—PP) as a white solid. The solid was cooled to room temperature and ground into a fine powder. To a solution of sodium chloride (10.0 g) in water (150 mL), 20.0 g of the K—PP (in powder form) was added portion by portion with vigorous stirring and kept stirred at room temperature for 7 h. The mixture was then boiled for 1.5 h to dissolve the powder. The suspension was cooled at 4° C. overnight, causing phase separation into two liquid layers. The lower layer is a coacervate of polyphosphate. The coacervate material can be a Na/K polyphosphate material where the K—PP is dissolved by Na⁺ (from NaCl) via an ion exchange with keeping the polyphosphate from recrystallization. The high ion intensity of the solution induces phase separation to cause coacervation of the polyphosphate. Though, use of NaCl is for exemplary purposes only and can be replaced by other inorganic salts. Further, coacervate is composed mostly of the polyphosphate but contains water as well. The upper layer was removed by decantation.

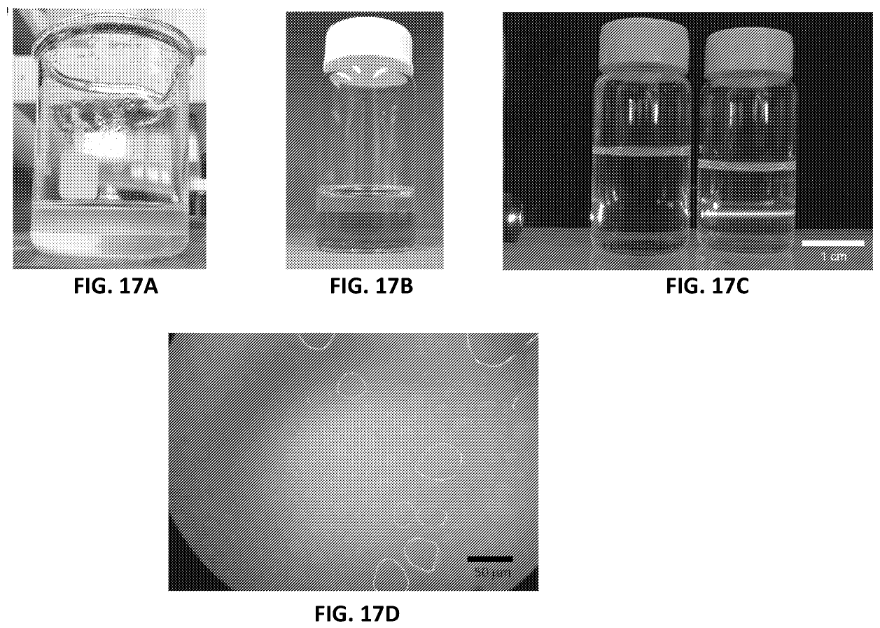

FIGS. 17A-17D show an example of coacervation of polyphosphate materials. In this example, a potassium polyphosphate powder was stirred into a boiling solution of sodium chloride (20 wt %) in water. Coacervation of polyphosphate was observed during dissolution of K—PP in the brine (20 wt % NaCl). High molecular-weight PP can coacervate by itself in water with increased ion intensity. The powder became a transparent fluid that was suspended in the solution. As shown in FIG. 17A, cooling the suspension to 4° C. caused biphasic separation. Standing the suspension at room temperature caused biphasic phase separation. The lower layer is a coacervate of polyphosphate, and it is more viscous than the upper aqueous layer. Note that the biphasic separation remained for more than 3 months at room temperature, suggesting that the phase separation slows hydrolysis of polyphosphate in water. As shown in FIG. 17B, the coacervate layer of the biphasic mixture was selectively colored blue by addition of copper (II) sulfate CuSO₄, due to chelation of Cu²⁺ by the polyphosphate coacervate. As shown in FIG. 17C, dilution of the suspension with water dispersed the coacervate in water, which was confirmed by observing the Tyndall effect where the Tyndall effect can hold true with or without the addition of multivalent salts (e.g., copper sulphate). The right and left glass vials contained 3.3 wt % saline with 6.7 wt % of K—PP (right) and without K—PP (left), respectively. A red laser beam was irradiated from the left-hand side to penetrate both vials. In the vial on the right, the laser beam was scattered by the coacervates in solution, while in the solution on the left, the laser beam was transmitted. FIG. 17D shows a droplet of the dispersion on a glass slide was observed by optical microscopy. As water evaporated, microdroplets of the coacervate merged into larger droplets. Microdroplets also merged into large droplets during cooling to 4° C. The microdroplets remained in the saline for more than three months at room temperature. This stability against hydrolysis can be ascribed to the reduction of charge repulsion within a PP chain and phase separation of the polyphosphates from bulk water.

### D. Polyphosphate Hydrogels

To prepare a polyphosphate hydrogel, 2.0 g of the polyphosphate coacervate described above was placed in a polystyrene container with 100 μL of a 10 wt % dispersion of zinc oxide nanoparticles in water. The mixture was mixed by using a plastic spoon until gelling. The gel was subsequently kneaded with a powder-free latex glove until the gel surface was no longer sticky. In this example, the polyphosphate material can be a Na/K—PP material. Though, the material can be a single or a combination of different cations.

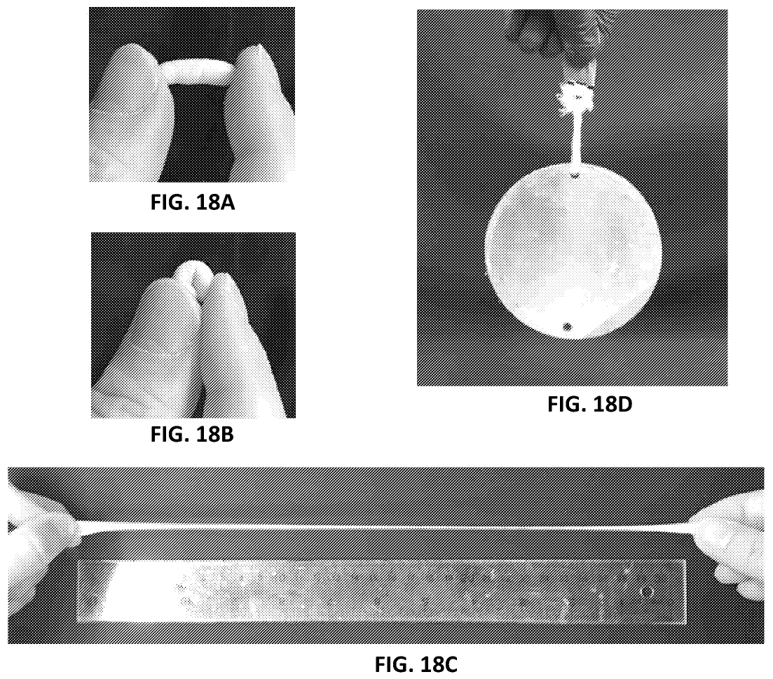

FIGS. 18A-18D show an exemplary Na/K—PP polyphosphate hydrogel. The polyphosphate hydrogel was formed by mixing a coacervate of polyphosphate with zinc oxide nanoparticles. The material can be a Na/K—PP material, for example. Though, other cations besides Na/K can be used. The mechanical properties of the hydrogel, shown in FIG. 18A, varied while drying. The gel was initially soft and deformable. A block of the gel could be divided into smaller chunks but unified again by pressing them to each other. As shown in FIG. 18B, the gel could be bent with fingers. As shown in FIG. 18C, the gel can be stretched more than 20 times its original length. While drying, the gel became less deformable yet more tough. As shown in FIG. 18D, film of the hydrogel (1.2 g, 0.4 mm thick) that was left at room temperature overnight could lift 350 g of a metal block. The film was ruptured in several seconds after hanging the metal block in the air.

### E. Polyphosphate Solutions and Coatings

To prepare polyphosphate coating, 200 mL of water was added to the polyphosphate coacervate (20 mL) and stirred at 4° C. overnight. A piece of filter paper (diameter: 5.5 cm) was dipped in the resultant solution. After removal of excess water with a piece of tissue paper, the polyphosphate-coated paper was dried in a desiccator under a reduced pressure. Though, a polyphosphate coating can also be formed using a melt or a solution. A Na/K—PP material can be used to form the polyphosphate coating. Moreover, a solution of commercially available Na—PP oligomers can also be used.

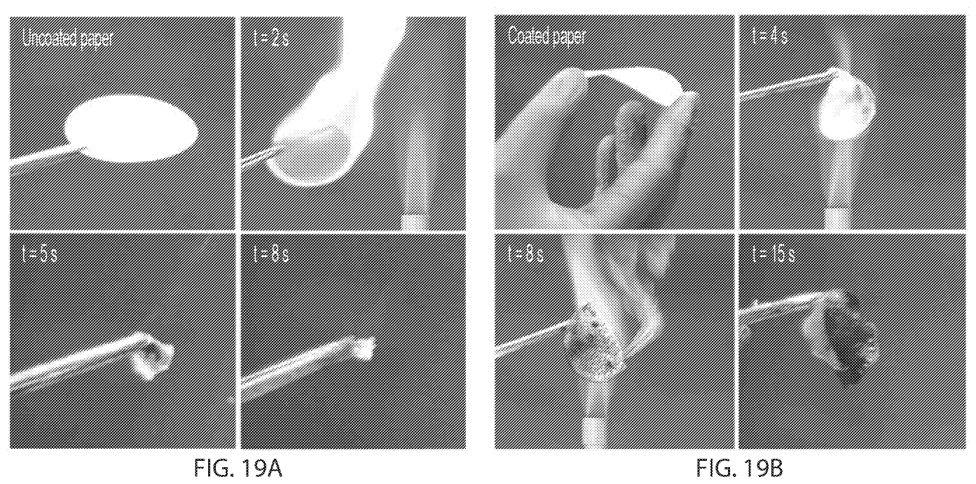

FIGS. 19A-19B show that polyphosphate coatings can be used for fire-proof coatings. FIG. 19A shows an uncoated piece of filter paper (diameter: 5.5 cm) after exposure to a flame for 2 s, 5 s, and 8 s. The uncoated filter paper caught fire when approaching flame in air and burned out to CO₂ within 10 seconds. FIG. 19B shows the same filter paper coated with polyphosphate material after exposure to a flame for 4 s, 8 s, and 15 s. Further, the polyphosphate coating can be either a plasticized (e.g., mixed cation) or a single-cation PP. For example, the polyphosphate coating can be a coacervate of Na/K—PP. The polyphosphate-coated paper became graphitized in flame with the shape of the sheet maintained. These results suggest that polyphosphate coating can shield flammable materials from reacting with oxygen.

### F. Polyphosphate Adhesives

To prepare a polyphosphate adhesive, an equimolar mixture of sodium dihydrogen phosphate monohydrate (1.37 g, 10 mmol) and potassium dihydrogen phosphate (1.36 g, 10 mmol) was dissolved in 5 mL of water. 500 μL of the solution was dropped onto the bottom (diameter: 2.7 cm) of an upside-down glass vial (weight: 1.4 g). The same procedure was repeated for a second glass vial. The two upside-down vials with the solution on the bottom were placed in a desiccator under a reduced pressure for 5 h to remove excess water. The vials were subsequently transferred into an oven. In the oven, one vial stood on the other vial that was upside-down, facing their bottoms. The pair of vials were heated at 500° C. for 5 h and then cooled to room temperature.

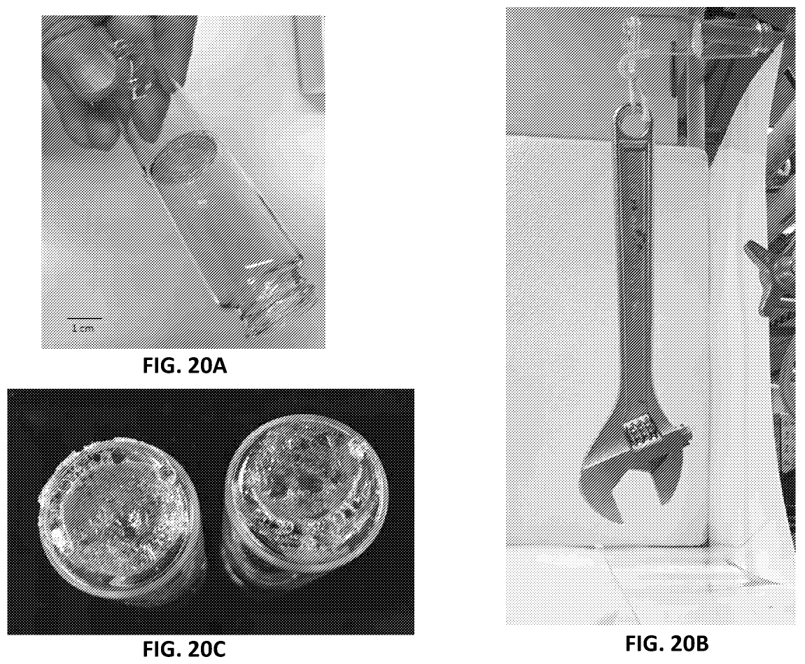

FIGS. 20A-20C show use of a polyphosphate adhesive to adhere glass to glass. FIG. 20A shows two glass vials (1.4 g each) glued together with sodium-potassium polyphosphate (Na/K—PP) (0.4 g) at the bottom (diameter: 2.7 cm), where the surface is slightly dented inward. As shown in FIG. 20 B, the glued vials were hooked on a monkey bar at one end, and a metal wrench (783 g) was hooked on the other end. The glue withstood the mechanical stress for 16 minutes and eventually fractured to detach the vials from each other. FIG. 20C shows the bottom of both glass vials after fracture. After the fracture, the glue remains adhered to the bottom of both glass vials.

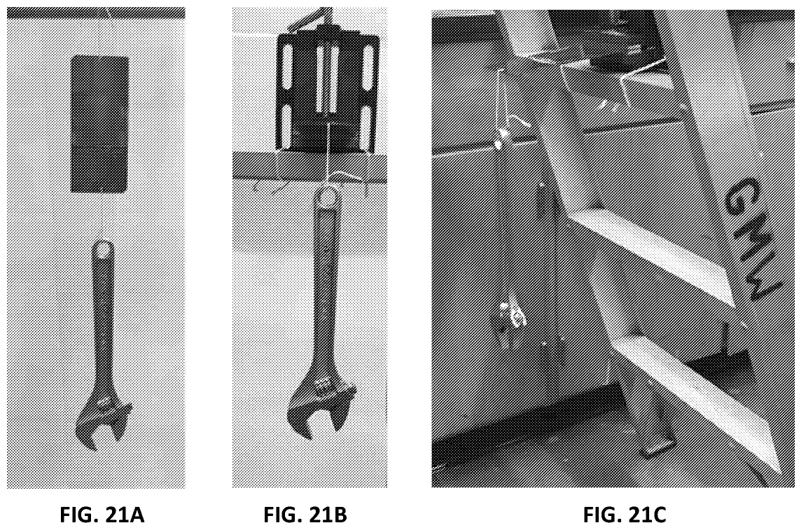

FIGS. 21A-21C show use of polyphosphate adhesive to adhere metal to metal. Two flat plates of stainless metal (for each, weight: 90 g, length: 12.4 cm, width: 8.1 cm, thickness 1 mm) were glued with sodium-potassium polyphosphate (Na/K—PP) (0.4 g). The plates were stacked with each other overlapping 6 cm in length. Small holes (diameter: 2 mm) were drilled ca. 5 mm away from the centers of the short edges of the glued plates. As shown in FIG. 21A, the glued plates were oriented vertically and hooked on a monkey bar at one end, and a metal wrench (783 g) was hooked on the other end with strings. The distance between the floor and the lowest level of the hanging wrench was about 30 cm. The glue had withstood the stress (parallel to the plates) for 3 days. As shown in FIG. 21B, the glued plates were also oriented horizontally and fixed at one end with a clamp that was fixed on a step of a ladder. FIG. 21C is a photo image of the setup in FIG. 21B taken from a different angle to show that the wrench was kept hanging on the opposite end of the glued plates to the clamped end. The distance between the floor and the lowest level of the hanging wrench was about 50 cm. The glue withstood the stress (orthogonal to the plates) for more than 1 week.

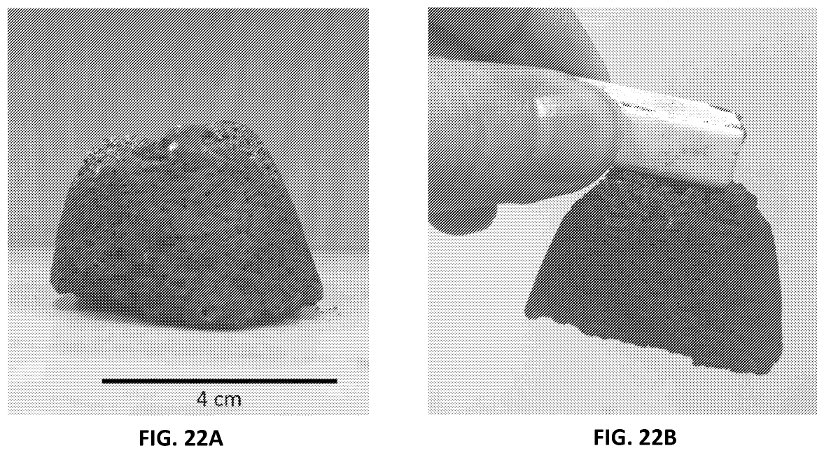

FIGS. 22A-22B show use of a polyphosphate adhesive for ceramic materials. As shown in FIG. 22A, Fe₃O₄ particles (23 g, diameters<5 μm) were glued together with Li/K—PP (20 g). As shown in FIG. 22B, the resultant block (43 g) was attracted by a magnet and lifted into the air.

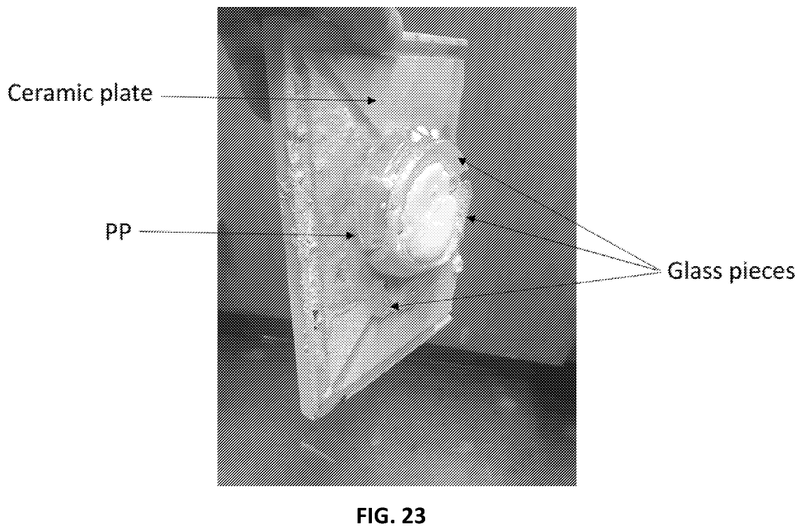

FIG. 23 shows use of a polyphosphate adhesive to adhere two different materials, for example glass and ceramic. FIG. 23 shows glass glued to ceramic with a lithium-potassium polyphosphate. A glass container that contained a melt of Li/K—PP was broken in an oven by accident. After cooling to room temperature, pieces of the broken glass were adhered to a ceramic plate on which the glass container was placed.

### G. Polyphosphate Films

To form a polyphosphate film, a piece of Li/K—PP solid was sandwiched with two sheets of Kapton™ (a polyimide film) and placed on an aluminum stage of a heat press machine. The solid was slowly pressed at 230° C. with increasing pressure and left at 3-10 atm (45-150 psi) at above 230° C. for 30 min. After cooling to room temperature, the pressure was released. The resulting polyphosphate film (flattened between the Kapton sheets) was taken out of the stage, and the Kapton sheets were peeled off from the polyphosphate film. Though, the provided pressure and temperature used are for example proposes only and can vary depending upon materials used.

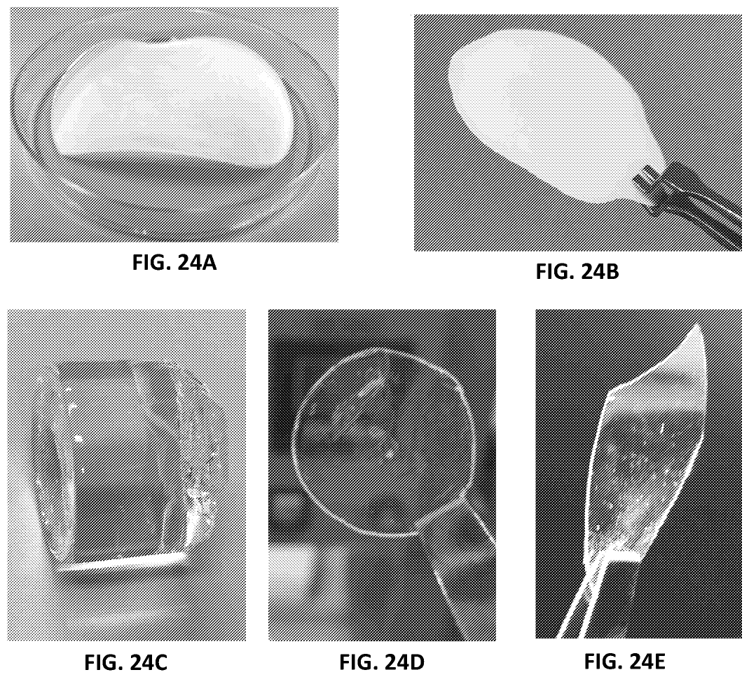

FIGS. 24A-24C show examples of plasticized polyphosphate films. Wet processes often give rise to white or opaque films, most likely due to formation of air bubbles and crystallization of remaining salts (such as NaCl) and hydrolysates of polyphosphate (such as orthophosphate) while drying the solution. FIG. 24A shows a sodium-potassium polyphosphate film formed by spreading a concentrated aqueous solution of Na—K—PP on a plastic dish and drying in a desiccator at 80° C. under a reduced pressure. This process resulted in a white, opaque film. FIG. 24B shows a polyphosphate hydrogel that is a Na—K—PP crosslinked material with ZnO that was flattened between plates of polystyrene and dried at room temperature. This process resulted in a white, opaque film. In contrast, melt processes using amorphous polyphosphate can afford transparent or translucent films. FIG. 24C shows a solid block of transparent lithium-potassium polyphosphate (Li/K—PP). This block was heat-pressed at 230° C. into a plate ca. 1 mm thick to form the film shown in FIG. 24D. The plate of Li—K—PP was further heat-pressed at a higher pressure into a film thinner than 0.5 mm, as shown in FIG. 24E.

### H. Hydrophobic Polyphosphate Materials

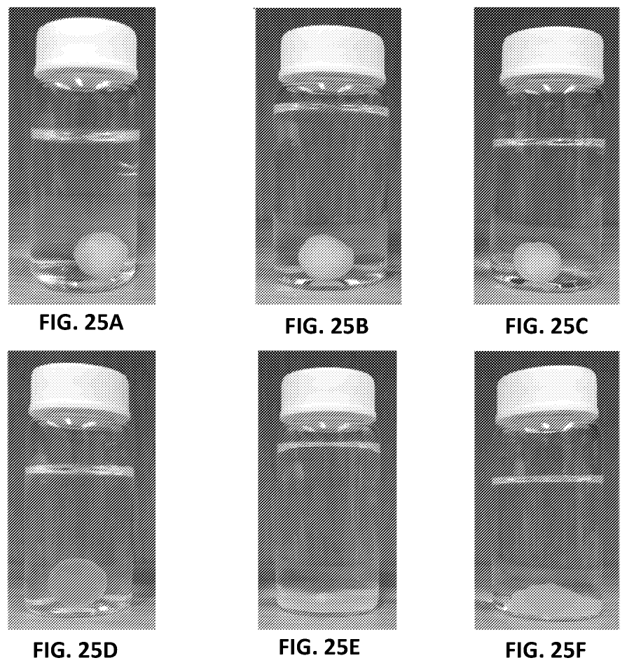

FIGS. 25A-25F show hydrophobic polyphosphate materials, specifically a Na/K—PP. Replacement of alkali metal ions with cetyltrimethylammonium ions caused precipitation of polyphosphates from water where an aqueous solution of Na/K—PP (K—PP dissolved in a NaCl solution) was added to an aqueous solution of cetyltrimethylammonium chloride. Further, the ion exchange in the reaction was driven by an increase of entropy. Though, Na/K—PP is for illustration purposes only and any Group I cation could be used. The precipitate was dried, divided into three blocks and rolled into ball shapes and soaked overnight in water, ethanol, and pentane. FIGS. 25A-25C show each polyphosphate ball in the respective solution on day one. FIG. 25A shows a ball in water, FIG. 25B shows a ball in ethanol, and FIG. 25C shows a ball in pentane. FIGS. 25E-25F show each polyphosphate ball after one week in the respective solutions. FIG. 25D shows a ball in water after one week, FIG. 25E shows a ball in ethanol after one week, and FIG. 25F shows a ball in pentane after one week. As shown in FIGS. 25E-25F, the ball shape collapsed in the organic solvents (ethanol and pentane) within a day, while, as shown in FIG. 25D, the ball retained its shape in water over a week, indicating that the ball is hydrophobic.

### III. Polyphosphate Foams

### A. Preparing Polyphosphate Foams

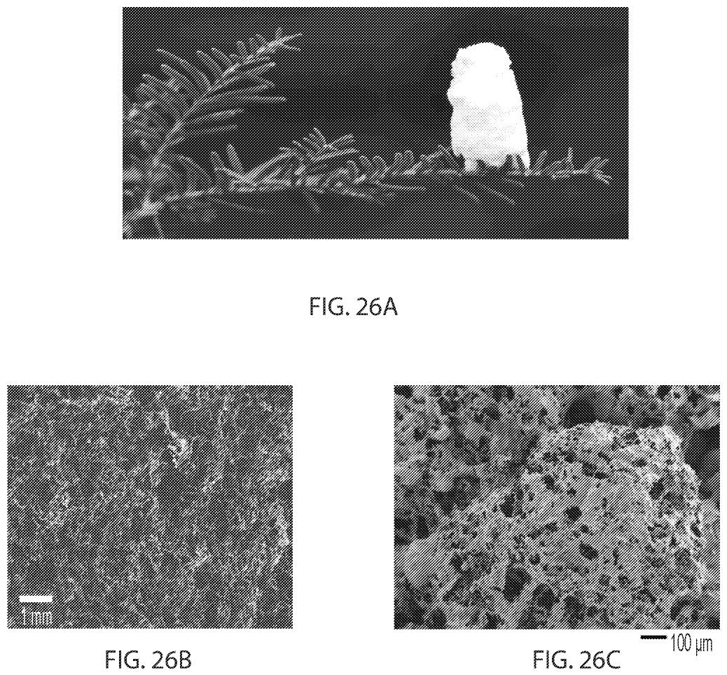

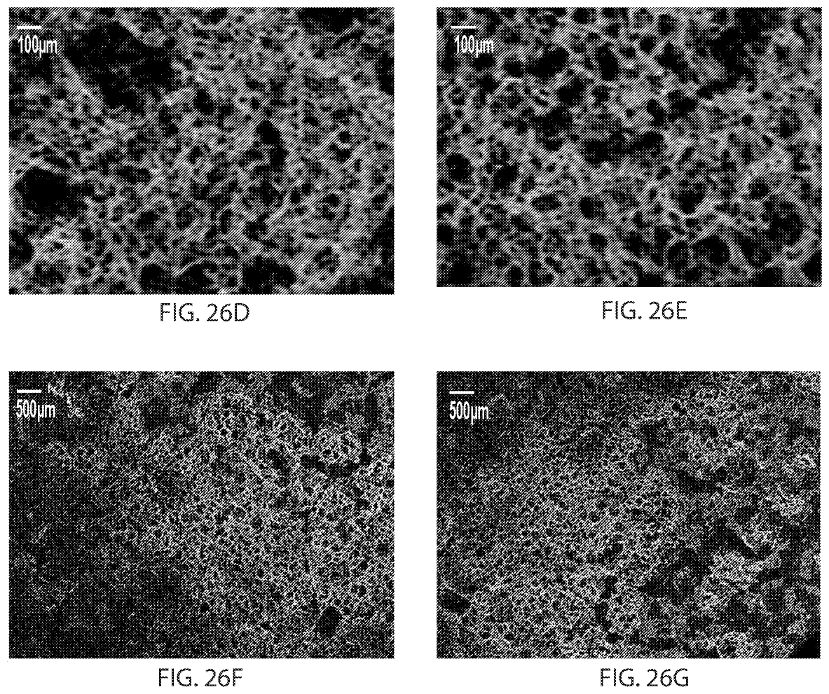

Thermal polycondensation of aluminum dihydrogen phosphate led to the formation of a polyphosphate foam. The foam has density from 0.05 to 0.1 g/cm³. FIG. 26A shows a photograph of an aluminum polyphosphate foam. As shown in FIG. 26B, X-ray microcomputed tomography (micro-CT) scanning shows an internal porous structure of the foam that is dominated by macropores. As shown in FIGS. 26C-26G, the structure was also analyzed by scanning electron microscope (SEM) at higher magnifications. The scale bar for FIGS. 26C-26E is 100 μm, and the scale bar for FIGS. 26F-26G is 500 μm. SEM visualized pores with diameters down to a few micrometers. Smaller pores were not observed. These results align with low surface area (1 −2 m²/g) obtained by Brunaeuer-Emmett-Teller (BET) analysis as well as high permeability of water across the foam (see below). X-ray photoelectron spectroscopy (XPS) analysis confirmed that the foam comprises aluminum polyphosphate (Al—PP).

### B. Layer-by-Layer Fabrication of Polyphosphate Foams

Polyphosphate foams were formed using a layer-by-layer fabrication. Powdered aluminum dihydrogen phosphate was sprinkled onto a stainless-steel plate. The steel plate can be 20 cm×20 cm×0.3 cm. It was followed by heating the layer of powder by blowing a flame from the top using a MAPP gas torch at a temperature around 2050° C. Though, the temperature is for example purposes only and can vary (e.g., between 500° C. to 2900° C.) The powder was heated until foaming stopped. This procedure was repeated to make a monolithic block of aluminum polyphosphate (Al—PP) foam layer by layer. The resulting PP monolith was cut into a desired shape by using a razor or a CO₂ laser cutter (10,600 nm, 35 W).

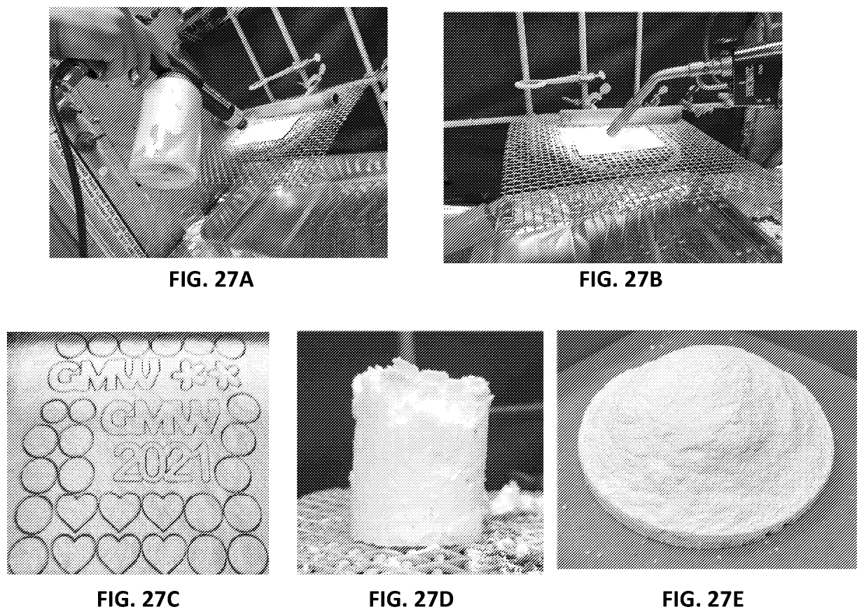

FIGS. 27A-27E show layer-by-layer fabrication and shaping of porous PP monoliths. As shown in FIG. 27A, powdered aluminum dihydrogen phosphate was sprinkled onto a stainless-steel plate by using a powder spray gun. As shown in FIG. 27B, a flame was then blown onto the powder layer from the top by using a MAPP gas torch until foaming stopped. These steps were repeated until the foam reached a desired height. This layer-by-layer fabrication prevents large voids from remaining inside the monolith and thereby improves mechanical stability of the monolith. As shown in FIGS. 27C-27E, the resulting monoliths were cut into desired shapes by using a CO₂ laser cutter (10,600 nm, 35 W).

### C. Mechanical Stability of Polyphosphate Foams

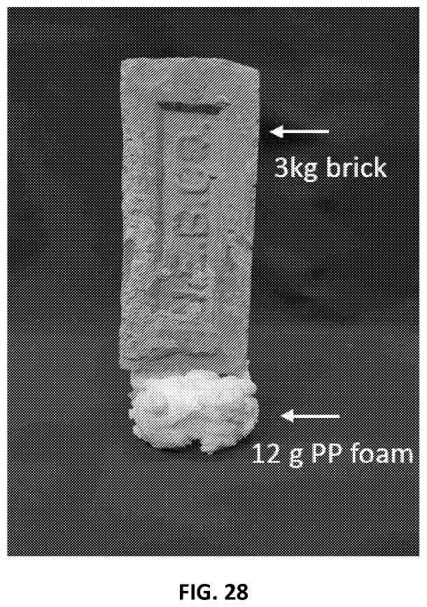

FIG. 28 shows a photograph of a brick (3 kg, ca. 20×9×5 cm³) loaded on an aluminum polyphosphate (Al—PP) foam (12 g). As shown in FIG. 28, 12 g of 0.05 g/cm³ phosphate foam can support a 3 g brick, demonstrating that polyphosphate foams can support at least 250 times their own weight. In fact, compression tests using an Instron instrument indicate that a plate of Al—PP (ca. 2.5 mm thick) fabricated by the layer-by-layer method can withstand 100-200 kPa before cracking. Preliminary dynamic mechanical analysis (DMA, compression mode) measurements show that the mechanical property (e.g., compressive stress (Young's modulus), storage modulus, and/or loss modulus) of the Al—PP foam is sustained between room temperature and 600° C. (and possibly higher), with E′ (storage modulus)=0.8-1 GPa and E″ (loss modulus)=40-80 MPa.

### D. Absorbance of Polyphosphate Foams

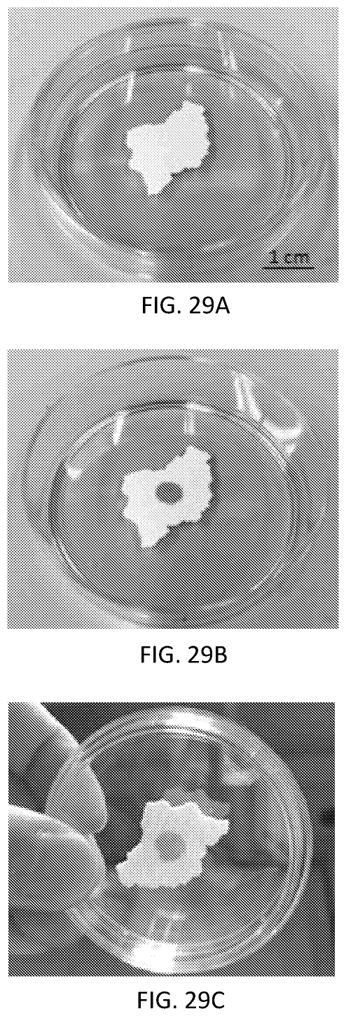

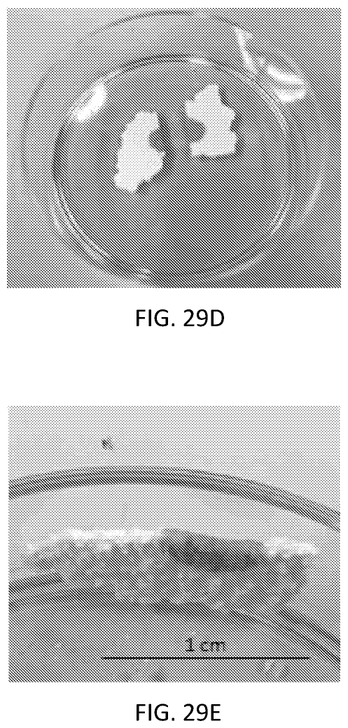

As shown in FIGS. 29A-28E, it was found that water permeates through the PP foam. FIG. 29A shows a 1 mm-thick slice of aluminum polyphosphate (Al—PP) foam. FIG. 29B shows 10 μL of an aqueous ink was dropped onto the aluminum polyphosphate. As shown in FIG. 29C, the ink instantaneously permeated across the foam as shown in the picture taken from the back side of the slice. As shown in FIG. 29D, the foam was cut with a razor across the center of the ink spot. FIG. 29E shows the slice leaned against the side wall of a Petri dish to inspect the cross section. This result confirms that pores inside the foam are not closed but interconnected to each other, forming a 3 D network of continuous channels, allowing the ink to permeate through the network.

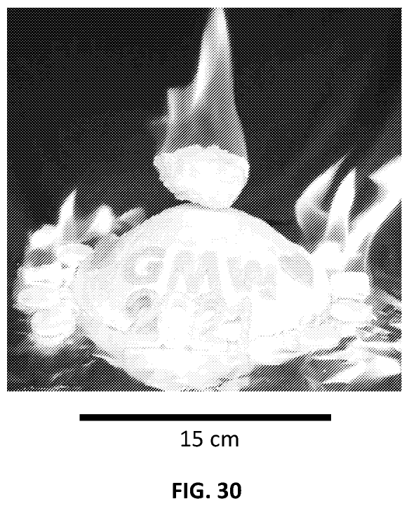

As shown in FIGS. 30, polyphosphate foams can also absorb and store organic solvents FIG. 30 shows a half spherical cake made of aluminum polyphosphate material decorated with smaller blocks of the same material. The smaller blocks are located on either side and are colored using inks. Further, the blocks in FIG. 30 placed at a periphery and/or on top of the cake are soaked with dyed ethanol and subsequently fire. Even after the fuel has caught fire, the polyphosphate blocks stayed intact, indicating that the polyphosphate foam is thermally stable. The foam could be handled by hand within a minute after the fire was extinguished, due to the ability of the polyphosphate foam to quickly dissipate heat.

### E. Thermal Insulation by Polyphosphate Foams

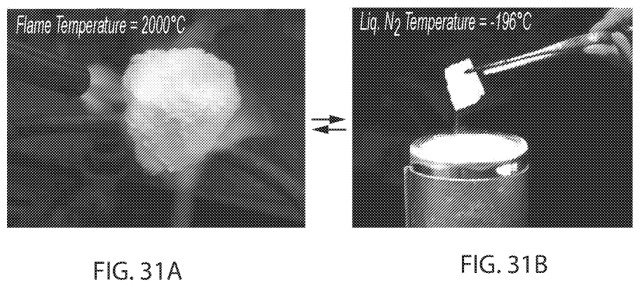

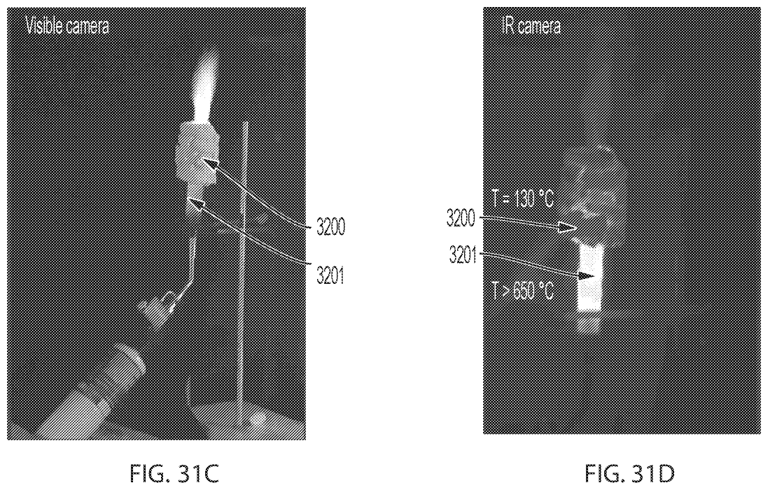

As shown in FIGS. 31A-31D, exemplary aluminum polyphosphate foams provide thermal insulation at extreme temperatures. FIG. 31A shows a polyphosphate foam exposed to a flame temperature of 2000° C. FIG. 31B shows the polyphosphate foam exposed to liquid nitrogen temperature of −196° C. The foam retained structural integrity during repeated drastic temperature changes between that of a flame (˜2000° C.) and liquid nitrogen (˜196° C.). Neither collapse of internal pores nor crack formation due to thermal expansion or shrinkage was observed. Even after exposing the foam to the flame for 20 seconds, liquid nitrogen that had been adsorbed within the foam remained, as was visible by the presence of liquid condensation that leached out of the surface of the foam. This observation suggests that the inside of the foam is thermally insulated.

FIGS. 31C-31D show a polyphosphate foam 3100 on a steel pipe 3101 being heated by using a MAPP gas torch (2000° C. flame). The outer surface of a steel tube was partially covered with PP foam and heated from the inside of the tube by using a MAPP gas torch. Surface temperatures were monitored by an IR camera. FIG. 31C shows a photograph and FIG. 31D shows an image from the infrared (IR) camera. The images are shown at steady-state, with 5 minutes of heating with the MAPP gas torch. After reaching thermal equilibrium, a larger than 500° C. difference was observed between uncoated surfaces (>650° C.) and coated surfaces (130° C.). With additional tuning of the polyphosphate foam, the temperature of the polyphosphate foam can be reduced to less than 70° C.

Preliminary results show that thermal conductivity of polyphosphate form at room temperature is about 0.03 W·m⁻¹·K⁻¹. This value is comparable to reported values of polyurethane foam (0.05 W·m⁻¹·K⁻¹) and silica aerogel (0.02 W·m⁻¹·K⁻¹). The thermal stability of polyphosphate foam is much higher than those common insulating materials, making polyphosphate foam useful for thermal insulation at extreme temperatures.

Table 1 shows a comparison of polyphosphate foams with silica aerogels and other insulating materials. As shown in Table 1, polyphosphate foams can withstand a wider range of temperatures.

TABLE 1
Comparison of Polyphosphate foams with other insulators.

| | Optimal thermal | Thermal | | | |
|---|---|---|---|---|---|
| | performance | Conductivity | | Density | |
| Polyphosphate | −70° C. to 800° C. | 0.03 | W · m⁻¹ · K⁻¹ | 0.05-0.15 | g/cm³ |
| foams | | | | | |
| CRYOGEL x201 | Up to 200° C. | 0.017 | W · m⁻¹ · K⁻¹ | 0.13 | g/cm³ |
| (Aspen Aerogels) | | | | | |
| PYROGEL HPS | Up to 650° C. | 0.022 | W · m⁻¹ · K⁻¹ | 0.20 | g/cm³ |
| (Aspen Aerogels) | | | | | |
| Lumira Aerogel | Up to 300° C. | 0.018 | W · m⁻¹ · K⁻¹ | 0.12-0.15 | g/cm³ |
| (Cabot) | | | | | |
| SpaceLoft Subsea | Up to 200° C. | 0.0145 | W · m⁻¹ · K⁻¹ | 0.16 | g/cm³ |
| (Aspen Aerogels) | | | | | |
| Polyurethane | Up to 80° C. | 0.05 | W · m⁻¹ · K⁻¹ | 0.1 | g/cm³ |
| Insulation | | | | | |
| Styrofoam | Up to 100° C. | 0.033 | W · m⁻¹ · K⁻¹ | 0.05 | g/cm³ |

### F. Thermal Degradation of Polyphosphate Foams

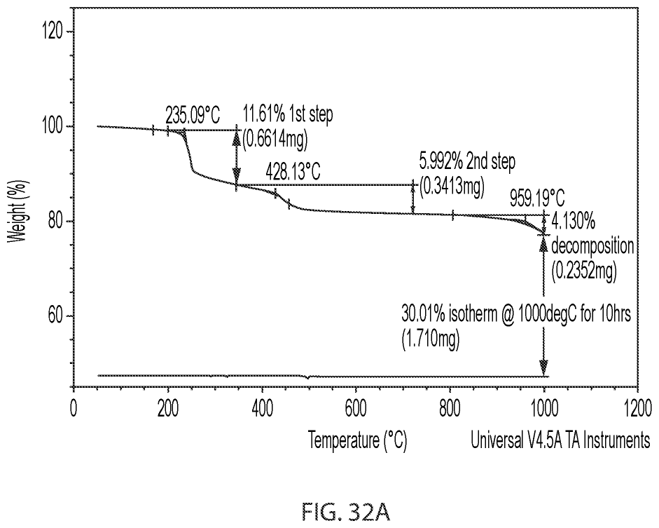

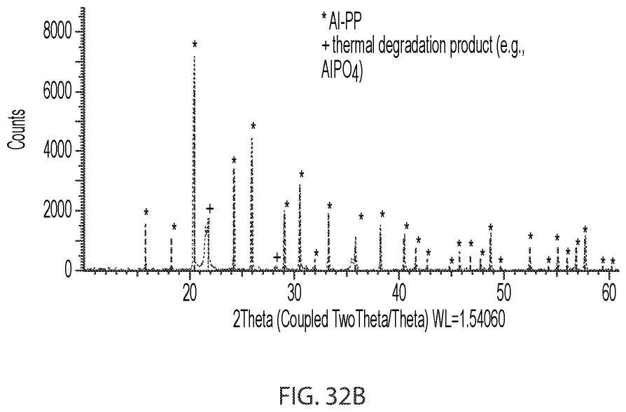

FIGS. 32A-32B show the thermal degradation of aluminum polyphosphate with the starting point of this example at the monomer. FIG. 32A shows thermogravimetric analysis (TGA) of aluminum polyphosphate. Thermogravimetric analysis indicates that the polymerization of Al(H₂PO₄)₃ proceeds via two reaction steps that occur at ca. 250 and 450° C. through the drop in weight percentage at the given temperatures. The product (Al—PP) begins to degrade at temperatures over 800° C. with a first indication of degradation occurring where the weight percentage begins to drop (e.g., between 950-960° C.). Heating Al—PP at 1000° C. for 10 h causes 30% weight loss.

A porous monolith of Al—PP was heated at 2000° C. (with a MAPP gas torch) for 10 min and analyzed by powder X-ray diffraction (XRD) analysis. The diffractogram, shown in FIG. 32B, confirms partial degradation of Al—PP (*) into AlPO₄ (+) as shown in the following reaction formula: Al(PO₃)₃→AlPO₄+P₂O₅T. Peaks corresponding to Al—PP are marked by*and peaks corresponding to AlPO₄ are marked by +. Further, more than half of the Al—PP was degraded into AlPO₄ due to the weight percentage dropping.

### G. Stability of Polyphosphate Foam in Water

In some embodiments, the degradation can be further reduced by making polyphosphate foams hydrophobic via a chemical treatment. Further, the surface of Al—PP foams can be hydrophobized via ion exchange. For example, sodium dodecyl sulfate can be introduced on the surface to delay the hydrolytic degradation.

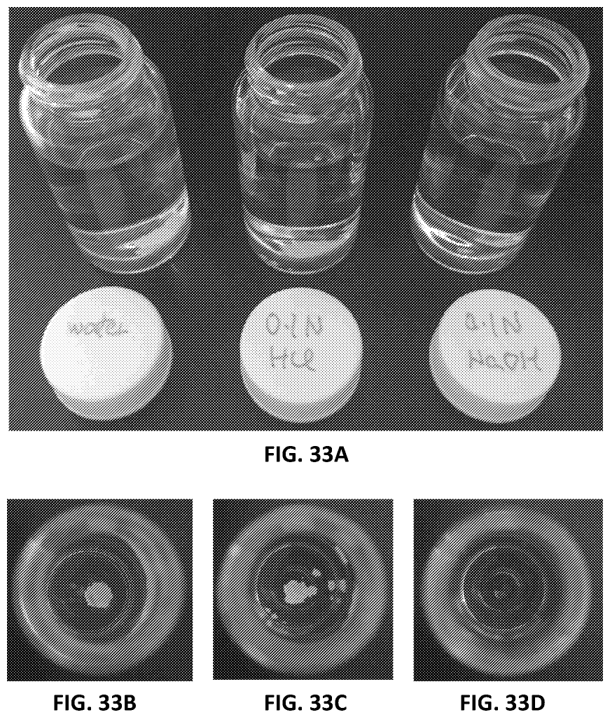

FIGS. 33A-33D show photographs of an exemplary aluminum polyphosphate foam in different solutions. Though, Al—PP is for example purposes only and other PP can be used. A piece of a polyphosphate monolithic foam (10 mg) was dipped into each of water, 0.1 N HClaq and 0.1 N NaOHaq (20 mL each) in glass vials and left at 30° C. for a month. FIG. 33A shows the polyphosphate foam in vial at the beginning. From the left to right, the vials contain water, HCl, and NaOH. FIGS. 33B-33D show observation of the vials from the top after one month. As shown in FIG. 33B, the polyphosphate monolith largely remained intact in water. As shown in FIG. 33C, the polyphosphate was partially broken into smaller pieces in 0.1 N HClaq. As shown in FIG. 33D, the polyphosphate was completely dissolved in 0.1 N NaOHaq. Note that 0.1 N NaOHaq dissolved the foam within a day.

### H. Polyphosphate Foam Composites

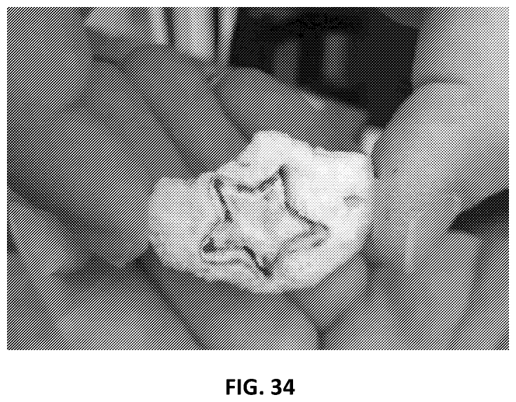

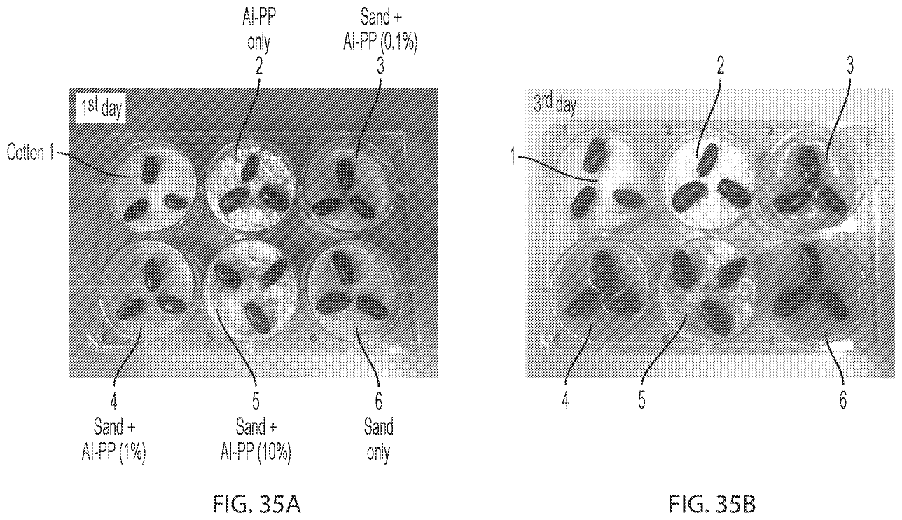

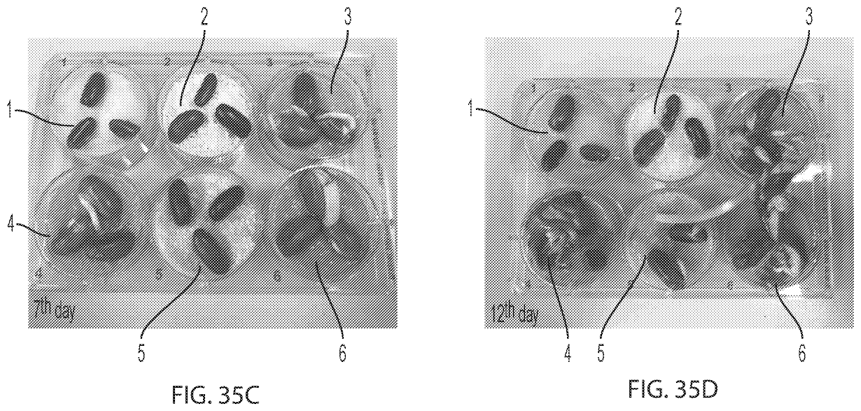

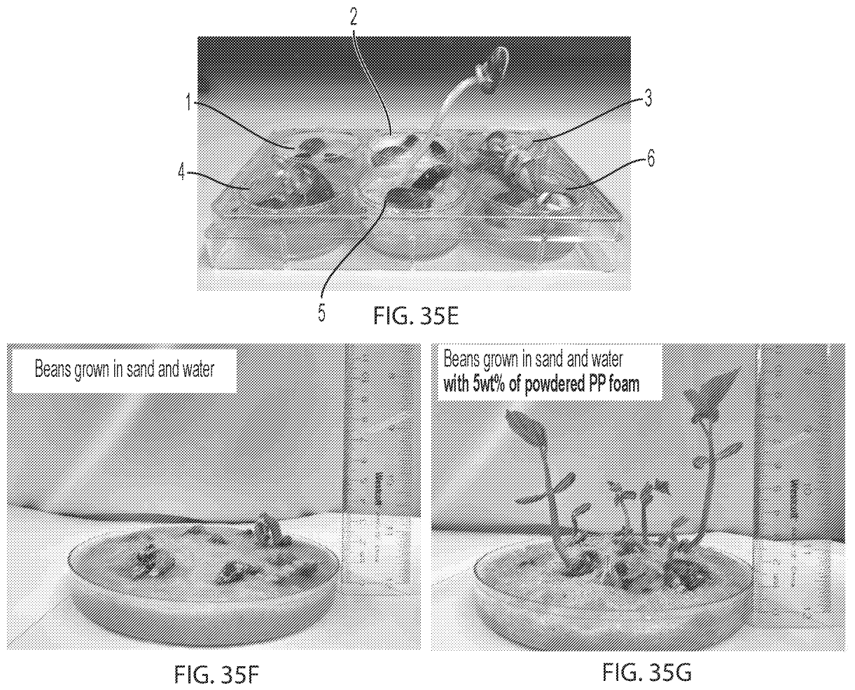

FIG. 34 shows a photograph of a polyphosphate foam with nano-silica that has been laser cut. Adding 5% nano-silica improves the mechanical properties of the foam. Polyphosphate/nano-silica composites can be laser-cut, for example, with a star as shown in FIG. 35.

### IV. Polyphosphate Fertilizers

Used polyphosphate materials can be reused as fertilizer. As shown in FIG. 35A, a six well polystyrene plate (in which wells are numbered as 1-6 from left top to right bottom as shown in the pictures) was used to grow red kidney beans on watered beds of supporting materials with different compositions as follows: 1) cotton (0.6 g); 2) powdered aluminum polyphosphate (Al—PP) foam (3 g); 3) sand (3 g) mixed with powdered Al—PP foam (0.1 wt %); 4) sand (3 g) mixed with powdered Al—PP foam (1 wt %); 5) sand (3 g) mixed with powdered Al—PP foam (10 wt %); 6) sand (3 g) only. Onto each bed of the supporting materials, three beans were planted and kept in dark. 3.0 mL of deionized water was given to each bed every day. FIG. 35B shows the plate on the third day, FIG. 35C shows the plate on the seventh day, and FIG. 35D shows the plate on the twelfth day. In two days after planted, a sprout emerged from a seed in well 4 (sand+1wt % Al—PP). Seeds in wells 3-6 were sprouted in a week. Sprouting of the seeds in wells 1 and 2 were retarded because the supporting materials absorbed water in competition with the beans. FIG. 35E shows a side view of the plate on the twelfth day. As shown in FIG. 35E, a seed in well 5 (sand mixed with 10 wt % of powdered Al—PP foam) grew faster than the others once sprouted.

As shown in FIGS. 35F-35G, red kidney beans were grown in sand (1 kg) without powdered Al—PP foam (FIG. 35F) and with 5 wt % powdered Al—PP foam (FIG. 35G). There were nine beans for each dish. Deionized water (100 mL) was added to each batch every other day. Growth of the plant was promoted in the sand mixed with the powdered polyphosphate foam. The height of plants in the sand mixed with powdered polyphosphate foam was up to 10 cm, while the height of plants in sand was a few centimeters or less. The pictures were taken in two weeks after planting. Note that the sand remained neutral in pH, indicating slow degradation of PP (and slow release of phosphate) for nutrition of the plant.

It will be appreciated that while one or more particular materials or steps have been shown and described for purposes of explanation, the materials or steps may be varied in certain respects, or materials or steps may be combined, while still obtaining the desired outcome. Additionally, modifications to the disclosed embodiment and the invention as claimed are possible and within the scope of this disclosed invention.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or ′comprising,” when used in this specification, specify the presence of stated features, integers, steps, operations, elements, and/or components, but do not preclude the presence or addition of one or more other features, integers, steps, operations, elements, components, and/or groups thereof.

1. A polyphosphate material comprising:
a plurality of polyphosphate chains having a backbone comprising oxygenphosphate bonds; and
two or more cations,
wherein the polyphosphate material is amorphous.

2. The polyphosphate material of claim 1, wherein the two or more cations are selected from a group consisting of monovalent cations, divalent cations, trivalent cations, tetravalent cations, and combinations thereof.

3. The polyphosphate material of claim 1, wherein the two or more cations are selected from the group consisting of lithium, sodium, potassium, rubidium, cesium, francium, ammonium, beryllium, magnesium, calcium, strontium, barium, radium, zinc, titanium, iron (Fe²⁺), chromium (Cr²⁺), manganese (Mn²⁺), cobalt (Co²⁺), nickel (Ni²⁺), copper (Cu²⁺), cadmium, tin (Sn²⁺), mercury (Hg²⁺), lead (Pb²⁺), aluminum, boron, gallium, iron (Fe³⁺), chromium (Cr³⁺), cobalt (Co³⁺), gold (Au³⁺), antimony (Sb³⁺), nickel (Ni³⁺), bismuth (Bi³⁺), manganese (Mn³⁺), zirconium, silicon, manganese (Mn⁴⁺), titanium (Ti⁴⁺), and combinations of thereof.

4. The polyphosphate material of claim 1, wherein the two or more cations comprise monovalent cations.

5. The polyphosphate material of claim 1, where the two or more cations comprise sodium and potassium.

6. The polyphosphate material of claim 1, wherein the two or more cations comprise potassium and lithium.

7. The polyphosphate material of claim 1, wherein the polyphosphate material has a glass transition temperature of less than 250° C.

8. The polyphosphate material of claim 1, wherein the polyphosphate material has a melting temperature less than 500° C.

9. The polyphosphate material of claim 1, wherein the polyphosphate material is transparent.

10. The polyphosphate material of claim 1, wherein the polyphosphate material is a gel.

11. The polyphosphate material of claim 10, wherein the gel comprises charged particles.

12. The polyphosphate material of claim 1, wherein the polyphosphate material is a thermoplastic material.

13. The polyphosphate material of claim 1, wherein the polyphosphate material is an adhesive.

14. The polyphosphate material of claim 1, wherein the polyphosphate material is a film.

15. The polyphosphate material of claim 1, wherein the polyphosphate material is hydrophobic.

16. The polyphosphate material of claim 1, further comprising hydrophobic cations.

17. The polyphosphate material of claim 1, further comprising a dissolved metal salt.

18. The polyphosphate material of claim 17, wherein the dissolved metal salt is selected from the group comprising copper salts, magnesium salts, chromium salts, europium salts, iron salts, titanium salts, chromium salts, manganese salts, cobalt salts, nickel salts, tin salts, mercury salts, lead salts, chromium salts, cobalt salts, gold salts, antimony salts, bismuth salts, and combinations thereof.

19. A method of forming a polyphosphate material comprising:
adding a polyphosphate powder comprising a first cation to a solution of a salt of a second cation;
heating the solution to dissolve the polyphosphate powder;
cooling the solution to cause phase separation into an upper liquid layer and a lower liquid layer, wherein the lower liquid layer comprises a coacervate of polyphosphate; and
collecting the coacervate.

20. (canceled)

21. (canceled)

22. (canceled)

23. (canceled)

24. (canceled)

25. (canceled)

26. (canceled)

27. (canceled)

28. (canceled)

29. A method of forming a polyphosphate material comprising: providing a first phosphate monomer comprising a first cation; providing a second phosphate monomer comprising a second cation; heating the first phosphate monomer and second phosphate monomer to form a liquid; and
cooling the liquid to form an amorphous polyphosphate material.

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. A polyphosphate material comprising:
a plurality of polyphosphate chains having a backbone comprising oxygenphosphate bonds; and
one or more multivalent cations forming crosslinks between the polyphosphate chains,
wherein the polyphosphate material is porous.

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. A method of forming a polyphosphate material comprising:
providing a mixture of a phosphate monomer comprising a multivalent cation; and
heating the mixture to form a polyphosphate foam.

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)
